(19) United States
(12) Patent Application Publication
(10) Pub. No.: US 2013/0190464 A1
(43) Pub. Date: Jul. 25, 2013

(54) PROCESS FOR PRODUCING SOLID CATALYST COMPONENT FOR OLEFIN POLYMERIZATION

(71) Applicant: Sumitomo Chemical Company, Limited, Tokyo (JP)

(72) Inventor: Yasuki FUJIWARA, Kawasaki-shi (JP)

(73) Assignee: Sumitomo Chemical Company, Limited, Tokyo (JP)

(21) Appl. No.: 13/649,166

(22) Filed: Oct. 11, 2012

(30) Foreign Application Priority Data
Oct. 11, 2011 (JP) 2011-223683

(51) Int. Cl. C08F 110/06

(52) U.S. Cl. CPC C08F 110/06
USPC 526/123.1; 502/104

(57) ABSTRACT

The present invention relates to a process for producing a solid catalyst component (A) for olefin polymerization, the process comprising the steps of:
(1) bringing a silicon compound (a) having a Si—O bond and an organomagnesium compound (b) into contact with one another to form a solid catalyst component precursor for olefin polymerization; and
(2) bringing the solid catalyst component precursor, a metal halide compound represented by formula (I): MX¹_{b}(R¹)_{4-b}
(I) and an internal electron donor represented by formula (II):

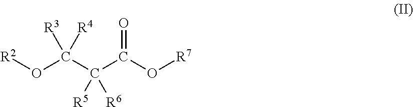

into contact with one another to form a solid catalyst component (A) for olefin polymerization.

### TECHNICAL FIELD

The present application is filed, claiming the priority based on the Japanese Patent Application No. 2011-223683 (filed on Oct. 11, 2011), and a whole of the content of this application is incorporated herein by reference.

The present invention relates to a process for producing a solid catalyst component for olefin polymerization, a process for producing an olefin polymerization solid catalyst using the solid catalyst component, and a process for producing an olefin polymer using the olefin polymerization solid catalyst.

### BACKGROUND ART

A large number of solid catalyst components containing a titanium atom, a magnesium atom, a halogen atom and an internal electron donor have been proposed as a solid catalyst component for olefin polymerization. It is desirable for a catalyst produced by using such a solid catalyst component to have a high polymerization activity and to have an ability to produce a polymer with a low content of low-molecular weight components and amorphous components, when an olefin is polymerized in the presence of the catalyst.

For example, a solid catalyst component obtained by treating a solid product obtained by bringing a silicon compound having a Si—O bond into contact with an organomagnesium compound in the presence of an organic acid ester, with an organic acid ester and successively a titanium halide compound is disclosed in JP 9-12623 A.

In addition, a solid catalyst component obtained by bringing a magnesium compound, a titanium compound, a halogen-containing compound and an alkoxy ester compound into contact with one another, and a solid catalyst component obtained by bringing an alkoxy ester compound into contact with a reaction product obtained by bringing a magnesium compound, a titanium compound and a halogen-containing compound into contact with one another are disclosed in JP 2-289604 A.

### DISCLOSURE OF INVENTION

### Problem to be Solved by the Invention

However, the olefin polymerization catalysts comprising a solid catalyst component, which are disclosed in the above documents, are still not entirely satisfactory from the viewpoint of their polymerization activity and their ability to produce a polymer with a low content of low-molecular weight components and amorphous components.

Therefore, an object of the present invention is to provide a process for producing an olefin polymerization solid catalyst having a sufficiently high polymerization activity and an ability to produce a polymer with a low content of low-molecular weight components and amorphous components, a process for producing an olefin polymerization solid catalyst component to be used for producing the olefin polymerization solid catalyst, and a process for producing an olefin polymer using the olefin polymerization solid catalyst.

### Means for Solving the Problem

The present invention relates to a process for producing a solid catalyst component (A) for olefin polymerization, the process comprising the following steps of:

(1) bringing a silicon compound (a) having a Si—O bond and an organomagnesium compound (b) into contact with one another to form a solid catalyst component precursor for olefin polymerization; and

(2) bringing the solid catalyst component precursor, a metal halide compound represented by formula (I):

MX¹_{b}(R¹)_{4-b} (I)

wherein M is an element of Group 4 of the periodic table, R¹ is a hydrocarbyl group or a hydrocarbyloxy group having 1 to 20 carbon atoms, X¹ is a halogen atom, and b is an integer number satisfying 0<b≦4,

and an internal electron donor represented by formula (II):

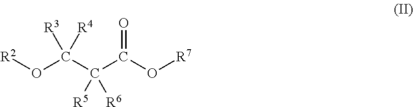

wherein R² and R⁷ are each independently a hydrocarbyl group having 1 to 20 carbon atoms and optionally having a substituent, R³, R⁴, R⁵ and R⁶ are independently a hydrogen atom, a halogen atom or a hydrocarbyl group having 1 to 20 carbon atoms and optionally having a substituent,
   into contact with one another to form a solid catalyst component (A) for olefin polymerization.

The present invention also relates to a process for producing an olefin polymerization solid catalyst, the process comprising a step of bringing the solid catalyst component (A) for olefin polymerization produced by the aforementioned process, an organoaluminum compound (B) and optionally an external electron donor (C) into contact with one another.

In addition, the present invention relates to a process for producing an olefin polymer, the process comprising a step of polymerizing an olefin in the presence of the olefin polymerization solid catalyst produced by the aforementioned process.

### Effect of the Invention

According to the present invention, a process for producing an olefin polymerization solid catalyst having a sufficiently high polymerization activity and an ability to produce an olefin polymer with a low content of low-molecular weight components and amorphous components, a process for producing an olefin polymerization solid catalyst component to be used for producing the olefin polymerization solid catalyst, and a process for producing an olefin polymer using the olefin polymerization solid catalyst can be provided.

### Modes for Carrying Out the Invention

The process for producing a solid catalyst component (A) for olefin polymerization according to the present invention comprises a step (1) of bringing a silicon compound (a) having a Si—O bond and an organomagnesium compound (b) into contact with one another to form a solid catalyst component precursor. Hereinafter, the solid catalyst component (A) for olefin polymerization is sometimes referred to as “solid catalyst component (A)”.

Examples of the silicon compound (a) having a Si—O bond include those represented by the following formula (I), (ii) or (iii):

Si(OR⁹)ₜR¹⁰₍₄₋ₜ₎ (i)

R¹¹(R¹²₂SiO)ᵤSiR¹³₃ (ii)

(R¹⁴₂SiO)ᵥ (iii)

wherein R⁹ to R¹⁴ are each independently a hydrocarbyl group having 1 to 20 carbon atoms or a hydrogen atom, t is an integer number of 1 to 4, u is an integer number of 1 to 1000, and v is an integer number of 2 to 1000.

As to R⁹ to R¹⁴ in the formulae (I), (ii) and (iii), examples of the hydrocarbyl group include an alkyl group such as a methyl group, an ethyl group, an n-propyl group, an isopropyl group, an n-butyl group, an isobutyl group, an n-pentyl group, an isopentyl group, a hexyl group, a heptyl group, an octyl group, a decyl group and a dodecyl group; an aryl group such as a phenyl group, a tolyl group, a xylyl group and a naphthyl group; a cycloalkyl group such as a cyclohexyl group and a cyclopentyl group; an alkenyl group such as an allyl group; and an aralkyl group such as a benzyl group.

In the formulae (i), (ii) and (iii), R⁹ to R¹⁴ are preferably an alkyl group having 2 to 18 carbon atoms or an aryl group having 6 to 18 carbon atoms, and particularly preferably a linear alkyl group having 2 to 18 carbon atoms.

Specific examples of the silicon compound having a Si—O bond represented by the formula (I), (ii) or (iii) include tetramethoxysilane, dimethyldimethoxysilane, tetraethoxysilane, triethoxyethylsilane, diethoxydiethylsilane, ethoxytriethylsilane, tetraisopropoxysilane, diisopropoxydiisopropylsilane, tetrapropoxysilane, dipropoxydipropylsilane, tetrabutoxysilane, dibutoxydibutylsilane, dicyclopentyloxydiethylsilane, diethoxydiphenylsilane, cyclohexyloxytrimethylsilane, phenoxytrimethylsilane, tetraphenoxysilane, triethoxyphenylsilane, hexamethyldisiloxane, hexaethyldisiloxane, hexapropyldisiloxane, octaethyltrisiloxane, dimethylpolysiloxane, diphenylpolysiloxane, methylhydropolysiloxane and phenylhydropolysiloxane.

The silicon compound having a Si—O bond is preferably a tetraalkoxysilane represented by the formula (i) wherein t is 4, and most preferably tetraethoxysilane.

The organomagnesium compound (b) is a compound containing a magnesium-carbon bond therein. Examples of the organomagnesium compound (b) include the compounds represented by the following formula (iv) or (v):

R¹⁵MgX³ (iv)

R¹⁶R¹⁷Mg (v)

wherein R¹⁵, R¹⁶ and R¹⁷ are each independently a hydrocarbyl group having 1 to 20 carbon atoms, and X³ is a halogen atom. As the organomagnesium compound (b), a Grignard compound represented by the formula (iv) is preferable, and an ether solution of the Grignard compound is particularly preferable, because a catalyst having good shape, can be obtained.

As to R¹⁵, R¹⁶ and R¹⁷ in the formulae (iv) and (v), examples of the hydrocarbyl group having 1 to 20 carbon atoms include an alkyl group, an aryl group, an aralkyl group and an alkenyl group, those groups having 1 to 20 carbon atoms, such as a methyl group, an ethyl group, an n-propyl group, an isopropyl group, an n-butyl group, a sec-butyl group, a tert-butyl group, an isopentyl group, a hexyl group, an n-octyl group, a 2-ethylhexyl group, a phenyl group, an allyl group and a benzyl group.

In the formulae (iv) and (v), R¹⁵, R¹⁶ and R¹⁷ are preferably an alkyl group having 2 to 18 carbon atoms or an aryl group having 6 to 18 carbon atoms, and particularly preferably an alkyl group having 2 to 18 carbon atoms.

Examples of X³ in the formula (iv) include a chlorine atom, a bromine atom and an iodine atom. Among them, a chlorine atom is particularly preferable.

Examples of the Grignard compound represented by the formula (iv) include methylmagnesium chloride, ethylmagnesium chloride, n-propylmagnesium chloride, isopropylmagnesium chloride, n-butylmagnesium chloride, isobutylmagnesium chloride, tert-butylmagnesium chloride, n-pentylmagnesium chloride, isopentylmagnesium chloride, cyclopentylmagnesium chloride, n-hexylmagnesium chloride, cyclohexylmagnesium chloride, n-octylmagnesium chloride, 2-ethylhexylmagnesium chloride, phenylmagnesium chloride and benzylmagnesium chloride. Among them, ethylmagnesium chloride, n-propylmagnesium chloride, isopropylmagnesium chloride, n-butylmagnesium chloride and isobutylmagnesium chloride are preferable, and n-butylmagnesium chloride is particularly preferable.

These Grignard compounds are preferably used in the form of an ether solution thereof. Examples of the ether include a dialkyl ether such as diethyl ether, di-n-propyl ether, diisopropyl ether, di-n-butyl ether, diisobutyl ether, ethyl n-butyl ether and diisopentyl ether, as well as a cyclic ether such as tetrahydrofuran. Among them, a dialkyl ether is preferable, and di-n-butyl ether and diisobutyl ether are particularly preferable.

In the step (1), a solvent may be used. Examples of the solvent include aliphatic hydrocarbon solvents such as hexane, heptane, octane and decane; aromatic hydrocarbon solvents such as toluene and xylene; alicyclic hydrocarbon solvents such as cyclohexane, methylcyclohexane and decalin; ether solvents, for example, dialkyl ether such as diethyl ether, di-n-propyl ether, diisopropyl ether, di-n-butyl ether, diisobutyl ether, ethyl n-butyl ether and diisopentyl ether, and a cyclic ether such as tetrahydrofuran; halogenated hydrocarbon solvents such as dichloromethane, 1,2-dichloroethane, perfluorooctane, chlorobenzene, dichlorobenzene, trifluoromethylbenzene, chloromethylbenzene and chlorocyclohexane; and combinations of two or more thereof. Among them, aliphatic hydrocarbon solvents, aromatic hydrocarbon solvents and alicyclic hydrocarbon solvents are preferable, aliphatic hydrocarbon solvents and alicyclic hydrocarbon solvents are more preferable, aliphatic hydrocarbon solvents are still more preferable, and hexane and heptane are particularly preferable.

In the step (1), it is preferable to use the organomagnesium compound (b) in an amount so that the total amount of the silicon atom contained in the silicon compound (a) and the organic acid ether (c) described below may be usually 0.1 mol to 10 mol, preferably 0.2 mol to 5.0 mol, and particularly preferably 0.5 mol to 2.0 mol, per 1 mol of the magnesium atoms which the organomagnesium compound (b) to be used contains.

It is preferable to add an organic acid ester (c) as an optional component, in the step (1), from the viewpoint of a polymerization activity and a content of low molecular weight components or amorphous components which the obtained polymer contains. As the organic acid ester (c), monocarboxylic acid esters and polycarboxylic acid esters may be used. Examples thereof are saturated aliphatic carboxylic acid esters, unsaturated aliphatic carboxylic acid esters, alicyclic carboxylic acid esters, aromatic carboxylic acid esters, carboxylic acid esters having a ketone group, and carboxylic acid esters having an ether bond.

Specific examples thereof include saturated aliphatic monocarboxylic esters such as methyl acetate, ethyl acetate, propyl acetate, butyl acetate, amyl acetate, n-hexyl acetate, phenyl acetate, methyl propionate, ethyl propionate, ethyl butyrate, ethyl valerate; unsaturated aliphatic monocarboxylic acid esters such as methyl acrylate, ethyl acrylate, and methyl methacrylate; aromatic monocarboxylic acid esters such as ethyl benzoate, propyl benzoate, isopropyl benzoate, butyl benzoate, isobutyl benzoate, amyl benzoate, n-hexyl benzoate, methyl toluate, ethyl toluate, and ethyl anisate; saturated aliphatic polycarboxylic esters such as diethyl malonate, dibutyl malonate, diethyl 2,2-diethylmalonate, diethyl succinate, and dibutyl succinate; unsaturated aliphatic polycarboxylic acid esters such as dimethyl maleate, dibutyl maleate, diethyl itaconate, and dibutyl itaconate; aromatic polycarboxylic acid esters such as monoethyl phthalate, dimethyl phthalate, methyl ethyl phthalate, diethyl phthalate, di-n-propyl phthalate, diisopropyl phthalate, di-n-butyl phthalate, diisobutyl phthalate, di-n-octyl phthalate, and dipentyl phthalate; carboxylic acid esters having a ketone group, such as butyl levulinate; and carboxylic acid esters having an ether bond, such as ethyl 3-ethoxypropionate, and ethyl 2-tert-butyl-3-ethoxypropionate. Among them, preferred are unsaturated aliphatic carboxylic acid esters such as methacrylic acid esters and maleic acid esters, and aromatic carboxylic acid esters such as benzoic acid esters and phthalic acid esters, and particularly preferred are diisobutyl phthalate and butyl benzoate.

The amount of the organic acid ester (c) to be used in the step (1) is usually 0.001 mol to 1 mol, preferably 0.05 mol to 0.5 mol, and particularly preferably 0.01 mol to 0.1 mol, per 1 mol of the silicon atoms which the silicon compound (a) having a Si—O bond contains.

When an organomagnesium compound (b) is added to a solution containing a silicon compound (a) having a Si—O bond and optionally an organic acid ester (c) and a solvent in the step (1), the organomagnesium compound (b) is added at a temperature of usually −50° C. to 100° C., preferably −30° C. to 70° C., and particularly preferably −25° C. to 50° C. The contacting time of the organomagnesium compound (b) with the silicon compound (a) having a Si—O bond and optionally an organic acid ester (c) is not particularly limited, and is usually from about 30 minutes to about 6 hours. It is preferable to add the organomagnesium compound (b) continuously so as to obtain a, catalyst having good shape. The reaction of the silicon compound (a) having a Si—O bond and optionally the organic acid ester (c) with the organomagnesium compound (b) may be further carried out for 30 minutes to 6 hours at 5° C. to 120° C. in order to promote the reaction.

In addition, it is possible to use a carrier in the step (1) so as to support the resultant solid catalyst component precursor on the carrier. Examples of the carrier include porous inorganic oxides such as SiO₂, Al₂O₃, MgO, TiO₂ and ZrO₂; and porous organic polymers such as polystyrene, a styrene-divinylbenzene copolymer, a styrene-ethylene glycol dimethacrylate copolymer, polymethyl acrylate, polyethyl acrylate, a methyl acrylate-divinylbenzene copolymer, polymethyl methacrylate, a methyl methacrylate-divinylbenzene copolymer, polyacrylonitrile, an acrylonitrile-divinylbenzene copolymer, polyvinyl chloride, polyethylene and polypropylene. Among them, preferred are porous organic polymers, and particularly preferred is a porous organic polymer which is composed of a styrene-divinylbenzene copolymer.

Preferred is a porous carrier in which a pore volume of pores having a pore radius of 20 nm to 200 nm is preferably 0.3 cm³/g or more, and more preferably 0.4 cm³/g or more, and the above pore volume is preferably 35% or more, and more preferably 40% or more relative to the pore volume of pores having a pore radius of 3.5 nm to 7500 nm, in order to efficiently support the solid catalyst component precursor on a carrier.

In the step (1), a component having a titanium atom is not used.

The solid catalyst component precursor obtained in the step (1) may be washed with a solvent. Examples of the solvent include aliphatic hydrocarbon solvents such as pentane hexane, heptane, octane and decane; aromatic hydrocarbon solvents such as benzene, toluene, ethylbenzene and xylene; alicyclic hydrocarbon solvents such as cyclohexane and cyclopentane; halogenated hydrocarbon solvents such as 1,2-dichloroethane and monochlorobenzene. Among them, aliphatic hydrocarbon solvents and aromatic hydrocarbon solvents are preferable, aromatic hydrocarbon solvents are more preferable, and toluene and xylene are particularly preferable.

The process for producing a solid catalyst component (A) for olefin polymerization according to the present invention comprises a step (2) of bringing the solid catalyst component precursor obtained in the step (1), a metal halide compound represented by formula (I) (hereinafter, sometimes referred to as “metal halide compound (I)”):

MX¹_{b}(R¹)_{4-b} (I)

wherein M is an element of Group 4 of the periodic table, R¹ is a hydrocarbyl group or a hydrocarbyloxy group having 1 to 20 carbon atoms, X¹ is a halogen atom, and b is an integer number satisfying 0<b≦4,

and an internal electron donor represented by formula (II) (hereinafter, sometimes referred to as “internal electron donor (II)”):

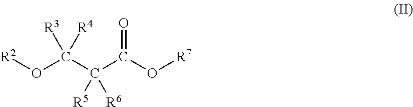

wherein R² and R⁷ are each independently a hydrocarbyl group having 1 to 20 carbon atoms and optionally having a substituent, R³, R⁴, R⁵ and R⁶ are independently a hydrogen atom, a halogen atom or a hydrocarbyl group having 1 to 20 carbon atoms and optionally having a substituent,

into contact with one another to form a solid catalyst component (A) for olefin polymerization.

As to M in the formula (I), the element of Group 4 of the periodic table may be titanium, zirconium and hafnium. Among them, titanium is preferable.

As to R¹ in the formula (I), examples of the hydrocarbyl group include a linear or branched alkyl group such as a methyl group, an ethyl group, an n-propyl group, an isopropyl group, an n-butyl group, an isobutyl group, an n-pentyl group, an isopentyl group, a hexyl group, a heptyl group, an octyl group, a decyl group and a dodecyl group; a cycloalkyl group such as a cyclohexyl group and a cyclopentyl group; an aryl group such as a phenyl group, a tolyl group, a xylyl group and a naphthyl group.

As to R¹ in the formula (I), examples of the hydrocarbyloxy group include a linear or branched alkoxy group such as a methoxy group, an ethoxy group, an n-propoxy group, an isopropoxy group, an n-butoxy group, an isobutoxy group, an n-amyloxy group, an isoamyloxy group, a hexyloxy group, a heptyloxy group, an octyloxy group, a decyloxy group and a dodecyloxy group; a cyclic alkoxy group such as a cyclohexyloxy group and a cyclopentyloxy group; an aryloxy group such as a phenoxy group, a xylyloxy group and a naphtoxy group.

In the formula (I), R¹ is preferably an alkyl or alkoxy group having 2 to 18 carbon atoms or an aryl or aryloxy group having 6 to 18 carbon atoms.

Examples of X¹ in the formula (I) include a fluorine atom, a chlorine atom, a bromine atom and an iodine atom. Among them, a chlorine atom and a bromine atom are preferable, and a chlorine atom is more preferable.

In the formula (I), b is an integer number satisfying 0<b≦4. Preferably, b is 3 or 4, and more preferably 4.

The metal halide compound (I) is preferably a titanium halide compound. Preferred examples thereof are titanium tetrahalide compounds such as titanium tetrachloride, titanium tetrabromide, and titanium tetraiodide; alkoxytitanium trihalide compounds such as methoxytitanium trichloride, ethoxytitanium trichloride, butoxytitanium trichloride, and ethoxytitanium tribromide; and aryloxytitanium trihalide compounds such as phenoxytitanium trichloride. Among them, titanium tetrahalide compounds are more preferable, and titanium tetrachloride is particularly preferable.

As to R² and R⁷ in the formula (II), the hydrocarbyl group may be an alkyl group, an aralkyl group, an aryl group, and an alkenyl group. Some or all hydrogen atoms which the hydrocarbyl group has may be substituted with a halogen atom, a hydrocarbyloxy group, a nitro group, a sulfonyl group and/or a silyl group.

Examples of the alkyl group for each R² and R⁷ include a linear alkyl group such as a methyl group, an ethyl group, an n-propyl group, an n-butyl group, an n-pentyl group, an n-hexyl group, an n-heptyl group and n-octyl group; a branched alkyl group such as an isopropyl group, an isobutyl group, a tert-butyl group, an isopentyl group, a neopentyl group and a 2-ethylhexyl group; a cycloalkyl group such as a cyclopropyl group, a cyclobutyl group, a cyclopentyl group, a cyclohexyl group, a cycloheptyl group and cyclooctyl group. Among them, a linear, branched or cyclic alkyl group having 1 to 20 carbon atoms is preferable, and a linear or branched alkyl group having 1 to 20 carbon atoms is more preferable.

Examples of the aralkyl group for each R² and R⁷ include a benzyl group and a phenethyl group. Preferred is an aralkyl group having 7 to 20 carbon atoms.

Examples of the aryl group for each R² and R⁷ include a phenyl group, a tolyl group and a xylyl group. Preferred is an aryl group having 6 to 20 carbon atoms.

Examples of the alkenyl group for each R² and R⁷ include a linear alkenyl group such as a vinyl group, an allyl group, a 3-butenyl group and a 5-hexenyl group; a branched alkenyl group such as an isobutenyl group and a 5-methyl-3-pentenyl group; and a cyclic alkenyl group such as a 2-cyclohexenyl group and a 3-cyclohexenyl group. Preferred is an alkenyl group having 2 to 20 carbon atoms.

R² and R⁷ in the formula (II) are independently preferably an alkyl group having 1 to 20 carbon atoms, more preferably a linear or branched alkyl group having 1 to 20 carbon atoms, still more preferably a methyl group, an ethyl group, an n-propyl group, an n-butyl, an n-pentyl group, an n-hexyl group, an n-heptyl group, an n-octyl group, an isopropyl group, an isobutyl group, a tert-butyl group, an isopentyl group, a neopentyl group, or a 2-ethylhexyl group, and particularly preferably a methyl group or an ethyl group.

As to R³ to R⁶ in the formula (II), examples of the halogen atom is a fluorine atom, a chlorine atom, a bromine atom and an iodine atom. Among them, a fluorine atom, a chlorine atom and a bromine atom is preferable.

As to R³ to R⁶ in the formula (II), the hydrocarbyl group may be an alkyl group, an aralkyl group, an aryl group, and an alkenyl group. Some or all hydrogen atoms which the hydrocarbyl group has may be substituted with a halogen atom, a hydrocarbyloxy group, a nitro group, a sulfonyl group and/or a silyl group.

Examples of the alkyl group for each R³ to R⁶ include a linear alkyl group such as a methyl group, an ethyl group, an n-propyl group, an n-butyl group, an n-pentyl group, an n-hexyl group, an n-heptyl group and n-octyl group; a branched alkyl group such as an isopropyl group, an isobutyl group, a tert-butyl group, an isopentylgroup, a neopentyl group and a 2-ethylhexyl group, a 1,1-dimethyl-2-methylpropyl group, a 1,1-dimethyl-2,2-dimethylpropyl group, a 1,1-dimethyl-n-butyl group, a 1,1-dimethyl-n-pentyl group and a 1,1-dimethyl-n-hexyl group; a cycloalkyl group such as a cyclopropyl group, a cyclobutyl group, a cyclopentyl group, a cyclohexyl group, a cycloheptyl group and cyclooctyl group. Preferred is a linear, branched or cyclic alkyl group having 1 to 20 carbon atoms.

Examples of the aralkyl group for each R³ to R⁶ include a benzyl group and a phenethyl group. Preferred is an aralkyl group having 7 to 20 carbon atoms.

Examples of the aryl group for each R³ to R⁶ include a phenyl group, a tolyl group and a xylyl group. Preferred is an aryl group having 6 to 20 carbon atoms.

Examples of the alkenyl group for each R³ to R⁶ include a linear alkenyl group such as a vinyl group, an allyl group, a 3-butenyl group and a 5-hexenyl group; a branched alkenyl group such as an isobutenyl group and a 5-methyl-3-pentenyl group; and a cyclic alkenyl group such as a 2-cyclohexenyl group and 3-cyclohexenyl group. Preferred is an alkenyl group having 2 to 20 carbon atoms.

R⁵ in the formula (II) is preferably an alkyl group having 1 to 20 carbon atoms or an aryl group having 6 to 20 carbon atoms, more preferably a branched or cyclic alkyl group having 3 to 20 carbon atoms or an aryl group having 6 to 20 carbon atoms, still more preferably a branched alkyl group such as an isopropyl group, an isobutyl group, a tert-butyl group, an isopentyl group, a neopentyl group, a 2-ethylhexyl group, a 1,1,2-trimethylpropyl group, a 1,1,2,2-tetramethylpropyl group, a 1,1-dimethylbutyl group, a 1,1-dimethylpentyl group and a 1,1-dimethylhexyl group; a cycloalkyl group such as a cyclopropyl group, a cyclobutyl group, a cyclopentyl group, a cyclohexyl group, a cycloheptyl group and a cyclooctyl group; or an aryl group such as a phenyl group, an o-tolyl group, a m-tolyl group, a p-tolyl group, a 2,6-dimethylphenyl group, a 2,4,6-trimethylphenyl group, an o-ethylphenyl group, a m-ethylphenyl group, a p-ethylphenyl group, a 2,6-diethylphenyl group, a 2,4,6-triethylphenyl group, a m-normalpropylphenyl group, and an m-isopropylphenyl group, particularly preferably a branched alkyl group such as an isopropyl group, an isobutyl group, a tert-butyl group, an isopentyl group, a neopentyl group, a 2-ethylhexyl group, a 1,1,2-trimethylpropyl group, a 1,1,2,2-tetramethylpropyl group, a 1,1-dimethylbutyl group, a 1,1-dimethylpentyl group and a 1,1-dimethylhexyl group; or an aryl group such as a phenyl group.

R⁶ in the formula (II) is preferably a hydrogen atom, an alkyl group having 1 to 20 carbon atoms or an aryl group having 6 to 20 carbon atoms, more preferably a hydrogen atom, a linear or branched alkyl group having 1 to 20 carbon atoms or an aryl group having 6 to 20 carbon atoms, still more preferably a hydrogen atom, a linear alkyl group such as a methyl group, an ethyl group, an n-propyl group, an n-butyl, an n-pentyl group, an n-hexyl group, an n-heptyl group and an n-octyl group; a branched alkyl group such as an isopropyl group, an isobutyl group, a tert-butyl group, an isopentyl group, a neopentyl group, a 2-ethylhexyl group, a 1,1,2-trimethylpropyl group, a 1,1,2,2-tetramethylpropyl group, a 1,1-dimethylbutyl group, a 1,1-dimethylpentyl group and a 1,1-dimethylhexyl group; or an aryl group such as a phenyl group, an o-tolyl group, a m-tolyl group, a p-tolyl group, a 2,6-dimethylphenyl group, a 2,4,6-trimethylphenyl group, an o-ethylphenyl group, a m-ethylphenyl group, a p-ethylphenyl group, a 2,6-diethylphenyl group, a 2,4,6-triethylphenyl group, a 3-propylphenyl group and a 3-isopropylphenyl group, particularly preferably a hydrogen atom or a linear alkyl group having 1 to 10 carbon atoms, such as a methyl group, an ethyl group, an n-propyl group, an n-butyl, an n-pentyl group, an n-hexyl group, an n-heptyl group and an n-octyl group, and most preferably a hydrogen atom, a methyl group, an ethyl group, an n-propyl group, an n-butyl or an n-pentyl group.

R³ and R⁴ in the formula (II) is independently preferably a hydrogen atom or an alkyl group having 1 to 10 carbon atoms, more preferably a hydrogen atom or a linear alkyl group having 1 to 10 carbon atoms, particularly preferably a hydrogen atom, a methyl group, an ethyl group, an n-propyl group, an n-butyl, or an n-pentyl group, and most preferably a hydrogen atom.

Examples of the internal electron donor (II) include ethyl 3-ethoxy-2-isopropylpropionate, ethyl 3-ethoxy-2-isobutylpropionate, ethyl 3-ethoxy-2-tert-butylpropionate, ethyl 3-ethoxy-2-tert-amylpropionate, ethyl 3-ethoxy-2-cyclohexylpropionate, ethyl 3-ethoxy-2-cyclopentyl propionate, ethyl 3-ethoxy-2-adamantylpropionate, ethyl 3-ethoxy-2-phenylpropionate, ethyl 3-ethoxy-2-(2,3-dimethylbutan-2-yl)propionate, ethyl 3-ethoxy-2-(2,3,3-trimethylbutan-2-yl)propionate, ethyl 3-ethoxy-2-(2-methylhexan-2-yl)propionate, ethyl 3-isobutoxy-2-isopropylpropionate, ethyl 3-isobutoxy-2-isobutylpropionate, ethyl 3-isobutoxy-2-tert-butylpropionate, ethyl 3-isobutoxy-2-tert-amylpropionate, ethyl 3-isobutoxy-2-cyclohexylpropionate, ethyl 3-isobutoxy-2-cyclopentylpropionate, ethyl 3-isobutoxy-2-adamantylpropionate, ethyl 3-isobutoxy-2-phenylpropionate, ethyl 3-methoxy-2-isopropylpropionate, ethyl 3-methoxy-2-isobutylpropionate, ethyl 3-methoxy-2-tert-butylpropionate, ethyl 3-methoxy-2-tert-amylpropionate, ethyl 3-methoxy-2-cyclohexylpropionate, ethyl 3-methoxy-2-cyclopentylpropionate, ethyl 3-methoxy-2-adamantylpropionate, ethyl 3-methoxy-2-phenylpropionate, ethyl 3-methoxy-2-(2,3-dimethylbutan-2-yl)propionate, ethyl 3-methoxy-2-(2,3,3-trimethylbutan-2-yl)propionate, ethyl 3-methoxy-2-(2-methylhexan-2-yl)propionate, methyl 3-ethoxy-2-isopropylpropionate, methyl 3-ethoxy-2-isobutylpropionate, methyl 3-ethoxy-2-tert-butylpropionate, methyl 3-ethoxy-2-tert-amylpropionate, methyl 3-ethoxy-2-cyclohexylpropionate, methyl 3-ethoxy-2-cyclopentylpropionate, methyl 3-ethoxy-2-adamantylpropionate, methyl 3-ethoxy-2-phenylpropionate, methyl 3-ethoxy-2-(2,3-dimethylbutan-2-yl)propionate, methyl 3-ethoxy-2-(2,3,3-trimethylbutan-2-yl)propionate, methyl 3-ethoxy-2-(2-methylhexan-2-yl)propionate, methyl 3-methoxy-2-isopropylpropionate, methyl 3-methoxy-2-isobutyl propionate, methyl 3-methoxy-2-tert-butylpropionate, methyl 3-methoxy-2-tert-amylpropionate, methyl 3-methoxy-2-cyclohexylpropionate, methyl 3-methoxy-2-cyclopentylpropionate, methyl 3-methoxy-2-adamantylpropionate, methyl 3-methoxy-2-phenylpropionate, methyl 3-methoxy-2-(2,3-dimethylbutan-2-yl)propionate, methyl 3-methoxy-2-(2,3,3-trimethylbutan-2-yl)propionate, methyl 3-methoxy-2-(2-methylhexan-2-yl)propionate, ethyl 3-ethoxy-3-isopropyl-2-isobutylpropionate, ethyl 3-ethoxy-3-isobutyl-2-isobutylpropionate, ethyl 3-ethoxy-3-isobutyl-2-tert-butylpropionate, ethyl 3-ethoxy-2,3-di-tert-butylpropionate, ethyl 3-ethoxy-3-isobutyl-2-tert-amylpropionate, ethyl 3-ethoxy-3-tert-butyl-2-tert-amylpropionate, ethyl 3-ethoxy-2,3-di-tert-amylpropionate, ethyl 3-ethoxy-3-isobutyl-2-cyclohexylpropionate, ethyl 3-ethoxy-2,3-dicyclohexylpropionate, ethyl 3-ethoxy-3-isobutyl-2-cyclopentylpropionate, ethyl 3-ethoxy-2,3-dicyclopentylpropionate, ethyl 3-ethoxy-2,3-diphenylpropionate, ethyl 3-methoxy-2,2-diisopropylpropionate, methyl 3-methoxy-2,2-diisopropylpropionate, ethyl 3-ethoxy-2,2-diisopropylpropionate, methyl 3-ethoxy-2,2-diisopropylpropionate, ethyl 3-ethoxy-2,2-diphenylpropionate, methyl 3-ethoxy-2,2-diphenylpropionate, methyl 3-methoxy-2-isopropyl-2-isobutylpropionate, ethyl 3-methoxy-2-isopropyl-2-isobutylpropionate, ethyl 3-ethoxy-2-isopropyl-2-isobutylpropionate, methyl 3-methoxy-2-isopropyl-2-tert-butylpropionate, ethyl 3-methoxy-2-isopropyl-2-tert-butylpropionate, ethyl 3-ethoxy-2-isopropyl-2-tert-butylpropionate, methyl 3-methoxy-2-isopropyl-2-tert-amylpropionate, ethyl 3-methoxy-2-isopropyl-2-tert-amylpropionate, ethyl 3-ethoxy-2-isopropyl-2-tert-amylpropionate, methyl 3-methoxy-2-isopropyl-2-cyclopentylpropionate, ethyl 3-methoxy-2-isopropyl-2-cyclopentylpropionate, ethyl 3-ethoxy-2-isopropyl-2-cyclopentylpropionate, methyl 3-methoxy-2-isopropyl-2-cyclohexylpropionate, ethyl 3-methoxy-2-isopropyl-2-cyclohexylpropionate, ethyl 3-ethoxy-2-isopropyl-2-cyclohexylpropionate, methyl 3-methoxy-2-isopropyl-2-phenylpropionate, ethyl 3-methoxy-2-isopropyl-2-phenylpropionate, ethyl 3-ethoxy-2-isopropyl-2-phenylpropionate, ethyl 3-methoxy-2,2-diisobutylpropionate, methyl 3-methoxy-2,2-diisobutylpropionate, ethyl 3-ethoxy-2,2-diisobutylpropionate, methyl 3-ethoxy-2,2-diisobutylpropionate, methyl 3-methoxy-2-isobutyl-2-tert-butylpropionate, ethyl 3-methoxy-2-isobutyl-2-tert-butylpropionate, ethyl 3-ethoxy-2-isobutyl-2-tert-butylpropionate, methyl 3-methoxy-2-isobutyl-2-tert-amylpropionate, ethyl 3-methoxy-2-isobutyl-2-tert-amylpropionate, ethyl 3-ethoxy-2-isobutyl-2-tert-amylpropionate, methyl 3-methoxy-2-isobutyl-2-cyclopentylpropionate, ethyl 3-methoxy-2-isobutyl-2-cyclopentylpropionate, ethyl 3-ethoxy-2-isobutyl-2-cyclopentylpropionate, methyl 3-methoxy-2-isobutyl-2-cyclohexylpropionate, ethyl 3-methoxy-2-isobutyl-2-cyclohexylpropionate, ethyl 3-ethoxy-2-isobutyl-2-cyclohexylpropionate, methyl 3-methoxy-2-isobutyl-2-phenylpropionate, ethyl 3-methoxy-2-isobutyl-2-phenylpropionate, ethyl 3-ethoxy-2-isobutyl-2-phenylpropionate, ethyl 3-methoxy-2,2-di-tert-butylpropionate, methyl 3-methoxy-2,2-di-tert-butylpropionate, ethyl 3-ethoxy-2,2-di-tert-butylpropionate, methyl 3-ethoxy-2,2-di-tert-butylpropionate, methyl 3-methoxy-2-tert-butyl-2-methylpropionate, ethyl 3-methoxy-2-tert-butyl-2-methylpropionate, ethyl 3-ethoxy-2-tert-butyl-2-methylpropionate, methyl 3-methoxy-2-tert-butyl-2-ethylpropionate, ethyl 3-methoxy-2-tert-butyl-2-ethylpropionate, ethyl 3-ethoxy-2-tert-butyl-2-ethylpropionate, methyl 3-methoxy-2-tert-butyl-2-n-propylpropionate, ethyl 3-methoxy-2-tert-butyl-2-n-propylpropionate, ethyl 3-ethoxy-2-tert-butyl-2-n-propylpropionate, methyl 3-methoxy-2-tert-butyl-2-n-butyl propionate, ethyl 3-methoxy-2-tert-butyl-2-n-butylpropionate, ethyl 3-ethoxy-2-tert-butyl-2-n-butylpropionate, methyl 3-methoxy-2-tert-butyl-2-n-pentylpropionate, ethyl 3-methoxy-2-tert-butyl-2-n-pentylpropionate, ethyl 3-ethoxy-2-tert-butyl-2-n-pentylpropionate, ethyl 3-ethoxy-2,2-dicyclohexylpropionate, and ethyl 3-ethoxy-2,2-dicyclopentylpropionate.

Among them, ethyl 3-ethoxy-2-tert-butylpropionate, ethyl 3-ethoxy-2-tert-amylpropionate, ethyl 3-ethoxy-2-cyclohexylpropionate, ethyl 3-ethoxy-2-cyclopentylpropionate, ethyl 3-ethoxy-2-phenylpropionate, ethyl 3-methoxy-2-phenylpropionate, methyl 3-ethoxy-2-phenylpropionate, methyl 3-methoxy-2-phenylpropionate, ethyl 3-ethoxy-2-(2,3-dimethylbutan-2-yl)propionate, ethyl 3-ethoxy-2-(2,3,3-trimethylbutan-2-yl)propionate, ethyl 3-ethoxy-2-(2-methylhexan-2-yl)propionate, ethyl 3-methoxy-2-tert-butylpropionate, methyl 3-ethoxy-2-tert-butylpropionate, methyl 3-methoxy-2-tert-butylpropionate, ethyl 3-ethoxy-3-isobutyl-2-tert-butylpropionate, ethyl 3-ethoxy-2,3-di-tert-butylpropionate, ethyl 3-ethoxy-3-tert-butyl-2-tert-amylpropionate, methyl 3-methoxy-2-isopropyl-2-tert-butylpropionate, ethyl 3-methoxy-2-isopropyl-2-tert-butylpropionate, ethyl 3-ethoxy-2-isopropyl-2-tert-butylpropionate, methyl 3-methoxy-2-isobutyl-2-tert-butylpropionate, ethyl 3-methoxy-2-isobutyl-2-tert-butylpropionate, ethyl 3-ethoxy-2-isobutyl-2-tert-butylpropionate, ethyl 3-methoxy-2,2-di-tert-butylpropionate, methyl 3-methoxy-2,2-di-tert-butylpropionate, ethyl 3-ethoxy-2,2-di-tert-butylpropionate, methyl 3-ethoxy-2,2-di-tert-butylpropionate, methyl 3-methoxy-2-tert-butyl-2-methylpropionate, ethyl 3-methoxy-2-tert-butyl-2-methylpropionate, ethyl 3-ethoxy-2-tert-butyl-2-methylpropionate, methyl 3-methoxy-2-tert-butyl-2-ethylpropionate, ethyl 3-methoxy-2-tert-butyl-2-ethylpropionate, ethyl 3-ethoxy-2-tert-butyl-2-ethylpropionate, methyl 3-methoxy-2-tert-butyl-2-n-propylpropionate, ethyl 3-methoxy-2-tert-butyl-2-n-propylpropionate, ethyl 3-ethoxy-2-tert-butyl-2-n-propylpropionate, methyl 3-methoxy-2-tert-butyl-2-n-butylpropionate, ethyl 3-methoxy-2-tert-butyl-2-n-butylpropionate, ethyl 3-ethoxy-2-tert-butyl-2-n-butylpropionate, methyl 3-methoxy-2-tert-butyl-2-n-pentylpropionate, ethyl 3-methoxy-2-tert-butyl-2-n-pentylpropionate, and ethyl 3-ethoxy-2-tert-butyl-2-n-pentylpropionate are preferable, and ethyl 3-ethoxy-2-tert-butylpropionate, ethyl 3-ethoxy-2-phenylpropionate, ethyl 3-ethoxy-2-(2,3-dimethylbutan-2-yl)propionate, ethyl 3-ethoxy-2-(2,3,3-trimethylbutan-2-yl)propionate, and ethyl 3-ethoxy-2-(2-methylhexan-2-yl)propionate are particularly preferable.

The metal halide compound (I) is used in an amount of usually 0.1 mmol to 1000 mmol, preferably 1 mmol to 100 mmol, and particularly preferably 6 mmol to 30 mmol, per 1 g of the solid catalyst component precursor. The metal halide compound (I) may be used all at once or dividedly in multiple times.

The internal electron donor (II) is used in an amount of usually 0.01 ml to 10 ml, preferably 0.03 ml to 5 ml, and particularly preferably 0.05 ml to 1 ml, per 1 g of the solid catalyst component precursor. The internal electron donor (II) may be used all at once or dividedly in multiple times.

The contacting time of the solid catalyst component precursor with the internal electron donor (II) and the metal halide compound (1) is usually 10 minutes to 12 hours, preferably 30 minutes to 10 hours, and particularly preferably 1 hour to 8 hours.

The contact temperature is usually −50° C. to 200° C., preferably 0° C. to 170° C., more preferably 50° C. to 150° C., and particularly preferably 50° C. to 120° C.

All contacts in the step (2) are usually carried out under an atmosphere of an inert gas such as nitrogen gas and argon gas. Examples of the step (2) of bringing the solid catalyst component precursor, the metal halide compound (I) and the internal electron donor (II) into contact with one another to produce a solid catalyst component (A) are as follows:

(2-1): a method comprising a step of adding the metal halide compound (I) and the internal electron donor (II), in any order, to the solid catalyst component precursor to produce a solid catalyst component (A);

(2-2): a method comprising a step of adding a mixture of the metal halide compound (I) and the internal electron donor (II) to the solid catalyst component precursor to produce a solid catalyst component (A);

(2-3): a method comprising a step of adding the internal electron donor (II) to the solid catalyst component precursor, and then adding the metal halide compound (I) thereto to produce a solid catalyst component (A);

(2-4): a method comprising a step of adding the internal electron donor (II) to the solid catalyst component precursor, and then adding, in any order, the metal halide compound (I) and the internal electron donor (II) thereto to produce a solid catalyst component (A);

(2-5): a method comprising a step of adding the internal electron donor (II) to the solid catalyst component precursor, and then adding a mixture of the metal halide compound (I) and the internal electron donor (II) thereto to produce a solid catalyst component (A);

(2-6): a method comprising a step of adding the solid catalyst component precursor and the internal electron donor (II), in any order, to the metal halide compound (I) to produce a solid catalyst component (A); and

(2-7): a method comprising a step of adding a mixture of the solid catalyst component precursor and the internal electron donor (II) to the metal halide compound (I) to produce a solid catalyst component (A).

Among the aforementioned methods (2-1) to (2-7), the methods (2-1), (2-2), (2-4) and (2-5) are preferable, and the methods (2-4) and (2-5) are more preferable.

Furthermore, solid catalyst components obtained by the following methods may be used as a solid catalyst component (A): a method which comprises a step of adding one or more times the metal halide compound to the solid catalyst component (A) obtained according to any one of the aforementioned methods (2-1) to (2-7); a method which comprises a step of adding one or more times the internal electron donor (II) and further metal halide compound (I), in any order, to the solid catalyst component (A) obtained according to any one of the aforementioned methods (2-1) to (2-7); and a method which comprises a step of adding one or more times a mixture of the internal electron donor (II) and the metal halide compound (I) to the solid catalyst component (A) obtained according to any one of the aforementioned methods (2-1) to (2-7).

In particular, the following methods (2-8) and (2-9) are preferable:

(2-8): a method comprising further step of adding, one or more times, preferably one time to five times, and more preferably one time to four times, the metal halide compound (I) and the internal electron donor (II) each to the solid catalyst component (A) obtained according to any one of the aforementioned methods (2-1) to (2-7) to produce a solid catalyst component (A); and

(2-9): a method comprising further step of adding, one or more times, preferably one time to five times, and more preferably one time to four times, a mixture of the internal electron donor (II) and the metal halide compound (I) to the solid catalyst component (A) obtained according to any one of the aforementioned methods (2-1) to (2-7) to produce a solid catalyst component (A).

In particular, the methods (2-8) and (2-9), in which the solid catalyst component (A) is that obtained by the aforementioned method (2-1), (2-2), (2-4) or (2-5), are preferable. The methods (2-8) and (2-9), in which the solid catalyst component (A) is that obtained by the aforementioned method (2-4) or (2-5), are particularly preferable.

An ether compound may be used in the step (2). Examples of the ether compound include a dialkyl ether such as diethyl ether, di-n-propyl ether, diisopropyl ether, di-n-butyl ether, diisobutyl ether, ethyl n-butyl ether and the diisopentyl ether and a cyclic ether such as tetrahydrofuran. Among them, a dialkyl ether is preferable, and di-n-butyl ether and diisobutyl ether are particularly preferable.

The step (2) is not particularly limited in its method for bringing the solid catalyst component precursor, the metal halide compound (I) and the internal electron donor (II) into contact with one another. For example, the known methods such as a slurry method and a mechanically-grinding method (for example, a method of grinding them with a ball mill) may be employed. The mechanically-grinding method is carried out preferably in the presence of a diluent to control an amount of fine powders which the obtained solid catalyst component (A) contains and broadening of a particle size distribution thereof. Examples of the diluent include aliphatic hydrocarbons such as pentane, hexane, heptane and octane; aromatic hydrocarbons such as benzene, toluene and xylene; alicyclic hydrocarbons such as cyclohexane and cyclopentane; and halogenated hydrocarbons such as 1,2-dichloroethane and monochlorobenzene. Among them, particularly preferred are aromatic hydrocarbons and halogenated hydrocarbons.

In the slurry method, the concentration of slurry is usually 0.05 to 0.7 g-solid/ml-solvent, and particularly preferably 0.1 to 0.5 g-solid/ml-solvent. The contact temperature is usually 30° C. to 150° C., preferably 45° C. to 135° C., and particularly preferably 60° C. to 120° C. The preferred contacting time is usually from 30 minutes to 6 hours.

The solid catalyst component (A) obtained in the step (2) is preferably washed with a solvent to remove impurities contained therein. The solvent is preferably inert to the solid catalyst component (A). Examples of the solvent are aliphatic hydrocarbons such as pentane, hexane, heptane and octane; aromatic hydrocarbons such as benzene, toluene and xylene; alicyclic hydrocarbons such as cyclohexane and cyclopentane; and halogenated hydrocarbons such as 1,2-dichloroethane and monochlorobenzene. Among them, particularly preferred are aromatic hydrocarbons or halogenated hydrocarbons. The amount of a solvent to be used for washing the solid catalyst component (A) is usually 0.1 ml to 1,000 ml, and preferably 1 ml to 100 ml, per 1 g of the solid catalyst component precursor, per one contact. Washing is carried out usually one time to five times after every contact, and is carried out usually at −50° C. to 150° C., preferably 0° C. to 140° C., and more preferably 60° C. to 135° C. The washing time is not particularly limited, and is preferably 1 minute to 120 minutes, and more preferably 2 minutes to 60 minutes.

It is possible to produce an olefin polymerization solid catalyst by bringing the solid catalyst component (A) of the present invention and the organoaluminum compound (B) and optionally an external electron donor (C) into contact with one another. The contact may be carried out by using any known method.

Examples of the organoaluminum compound (B) to be used in the present invention include the compounds as described in JP 10-212319 A. In particular, a trialkylaluminum, a mixture of a trialkylaluminum and a dialkylaluminum halide, and an alkylalumoxane are preferable, and triethylaluminum, triisobutylalminum, a mixture of triethylaluminum and diethylaluminum chloride, and tetraethyldialumoxane are more preferable.

Examples of the external electron donor (C) optionally to be used in the present invention include the compounds as described in JP 2950168 B2, JP 2006-96936 A, JP 2009-173870 A and JP 2010-168545 A. In particular, an oxygen-containing compound and a nitrogen-containing compound are preferable. Examples of the oxygen-containing compound are an alkoxysilane, an ether, an ester and a ketone compound. Among them, preferred are an alkoxysilane and an ether compound.

The alkoxysilanes represented by following formulae (v) to (vii) are preferable as the external electron donor (C)

R¹⁸ₕSi(OR¹⁹)₄₋ₕ (v)

Si(OR²⁰)₃(NR²¹R²²) (vi)

Si(OR²⁰)₃(NR²³) (vii)

In the above formulae, R¹⁸ is a hydrocarbyl group having 1 to 20 carbon atoms or a hydrogen atom, R¹⁹ is a hydrocarbyl group having 1 to 20 carbon atoms; and h is a number satisfying 0≦h<4. When there are more than one R¹⁸ groups, the R¹⁸ groups are the same or different. When there are more than one R¹⁹ groups, the R¹⁹ groups are the same or different. In the above formulae, R²⁰ is a hydrocarbyl group having 1 to 6 carbon atoms; R²¹ and R²² are independently a hydrogen atom or a hydrocarbyl group having 1 to 12 carbon atoms; and NR²³ is a cyclic amino group having 5 to 20 carbon atoms.

As to R¹⁸ and R¹⁹ in the formula (v), the hydrocarbyl group may be an alkyl group, an aralkyl group, an aryl group and an alkenyl group. Examples of the alkyl group for R¹⁸ and R¹⁹ include a linear alkyl group such as a methyl group, an ethyl group, an n-propyl group, an n-butyl group, an n-pentyl group, an n-hexyl group, an n-heptyl group and an n-octyl group; a branched alkyl group such as an isopropyl group, an isobutyl group, a tert-butyl group, an isopentyl group, a neopentyl group and a 2-ethylhexyl group; a cycloalkyl group such as a cyclopropyl group, a cyclobutyl group, a cyclopentyl group, a cyclohexyl group, a cycloheptyl group and cyclooctyl group. Among them, a linear, branched or cyclic alkyl group having 1 to 20 carbon atoms is preferable.

Examples of the aralkyl group for R¹⁸ and R¹⁹ include a benzyl group and a phenethyl group. Preferred is an aralkyl group having 7 to 20 carbon atoms.

Examples of the aryl group for R¹⁸ and R¹⁹ include a phenyl group, a tolyl group and a xylyl group. Preferred is an aryl group having 6 to 20 carbon atoms.

Examples of the alkenyl group for R¹⁸ and R¹⁹ include a linear alkenyl group such as a vinyl group, an allyl group, a 3-butenyl group and a 5-hexenyl group; a branched alkenyl group such as an isobutenyl group and a 5-methyl-3-pentenyl group; and a cyclic alkenyl group such as a 2-cyclohexenyl group and a 3-cyclohexenyl group. Preferred is an alkenyl group having 2 to 10 carbon atoms.

Examples of the alkoxysilane represented by the formula (v) include cyclohexylmethyldimethoxysilane, cyclohexylethyl dimethoxysilane, di-isopropyldimethoxysilane, tert-butylethyldimethoxysilane, tert-butyl-n-propyldimethoxysilane, phenyltrimethoxysilane, diphenyldimethoxysilane, dicyclobutyldimethoxysilane, dicyclopentyldimethoxysilane, tetraethoxysilane, methyltriethoxysilane, ethyltriethoxysilane, isobutyltriethoxysilane, vinyltriethoxysilane, sec-butyltriethoxysilane, cyclohexyltriethoxysilane, and cyclopentyltriethoxysilane.

As to R²⁰ in the formulae (vi) and (vii), the hydrocarbyl group may be an alkyl group or an alkenyl group. Examples of the alkyl group for R²⁰ include a linear alkyl group such as a methyl group, an ethyl group, an n-propyl group, an n-butyl group, an n-pentyl group, and an n-hexyl group; a branched alkyl group such as an isopropyl group, an isobutyl group, a tert-butyl group, an isopentyl group, and a neopentyl group; a cycloalkyl group such as a cyclopropyl group, a cyclobutyl group, a cyclopentyl group, and a cyclohexyl group. Among them, a linear alkyl group having 1 to 6 carbon atoms is preferable. Examples of the alkenyl group for R²⁰ include a linear alkenyl group such as a vinyl group, an allyl group, a 3-butenyl group and a 5-hexenyl group; a branched alkenyl group such as an isobutenyl group and a 5-methyl-3-pentenyl group; and a cyclic alkenyl group such as a 2-cyclohexenyl group and a 3-cyclohexenyl group. Preferred is a linear alkenyl group having 2 to 6 carbon atoms, and particularly preferred are a methyl group and an ethyl group.

As to R²¹ and R²² in the formula (vi), the hydrocarbyl group may be an alkyl group or an alkenyl group. Examples of the alkyl group for R²¹ and R²² include a linear alkyl group such as a methyl group, an ethyl group, an n-propyl group, an n-butyl group, an n-pentyl group, and an n-hexyl group; a branched alkyl group such as an isopropyl group, an isobutyl group, a tert-butyl group, an isopentyl group, and a neopentyl group; a cycloalkyl group such as a cyclopropyl group, a cyclobutyl group, a cyclopentyl group, and a cyclohexyl group. Among them, a linear alkyl group having 1 to 6 carbon atoms is preferable. Examples of the alkenyl group for R²¹ and R²² include a linear alkenyl group such as a vinyl group, an allyl group, a 3-butenyl group and a 5-hexenyl group; a branched alkenyl group such as an isobutenyl group and a 5-methyl-3-pentenyl group; and a cyclic alkenyl group such as a 2-cyclohexenyl group and a 3-cyclohexenyl group. Preferred is a linear alkenyl group having 2 to 6 carbon atoms, and particularly preferred are a methyl group and an ethyl group.

Examples of the alkoxysilane represented by the formula (vi) include dimethylaminotrimethoxysilane, diethylaminotrimethoxysilane, di-n-propylaminotrimethoxysilane, dimethylaminotriethoxysilane, diethylaminotriethoxysilane, di-n-propylaminotriethoxysilane, methylethylaminotriethoxysilane, methyl-n-propylaminotriethoxysilane, tert-butylaminotriethoxysilane, diisopropylaminotriethoxysilane, and methylisopropylaminotriethoxysilane.

As to NR²³ in the formula (vii), examples of the cyclic amino group are a perhydroquinolino group, a perhydroisoquinolino group, a 1,2,3,4-tetrahydroquinolino group, a 1,2,3,4-tetrahydroisoquinolino group, and an octamethyleneimino group.

Examples of the alkoxysilane represented by the formula (vii) include perhydroquinolinotriethoxysilane, perhydroisoquinolinotriethoxysilane, 1,2,3,4-tetrahydroquinolinotriethoxysilane, 1,2,3,4-tetrahydroisoquinolinotriethoxysilane, and octamethyleneiminotriethoxysilane.

Preferred ether compound as the external electron donor (C) is a cyclic ether compound. The cyclic ether compound is a heterocyclic compound comprising at least one —C—O—C— bond within the ring structure. Preferred is a cyclic ether compound which comprises at least one —C—O—C—O—C— bond within the ring structure, and particular preferable is 1,3-dioxolane or 1,3-dioxane.

The external electron donor (C) may be used alone or as a combination of two or more kinds thereof.

A method for bringing the solid catalyst component (A), the metal halide compound (B) and optionally the external electron donor (C) into contact with one another is not particularly limited insofar as an olefin polymerization solid catalyst can be produced therefrom. The contact may be carried out in the presence or absence of a solvent.

It is possible to supply the solid catalyst obtained by bringing all of the components into contact with one another to a polymerization reactor. Alternatively, it is possible to bring all of the components into contact with one another in a polymerization reactor after they are separately supplied to the polymerization reactor, or to bring some parts of those components into contact with the remaining parts of those components in a polymerization reactor after they are separately supplied to a polymerization reactor.

An olefin to be used in the process for producing an olefin polymer according to the present invention may be ethylene or an α-olefin having 3 or more carbon atoms. Examples of the α-olefin include a linear monoolefin such as propylene, 1-butene, 1-pentene, 1-hexene, 1-heptene, 1-octene and 1-decene; a branched monoolefin such as 3-methyl-1-butene, 3-methyl-1-pentene and 4-methyl-1-pentene; a cyclic monoolefin such as vinylcyclohexane. These olefins may be used alone or in combination of two or more thereof. In the present invention, it is preferred to homopolymerize ethylene or propylene or to copolymerize a mixed olefins comprising ethylene or propylene as a main component. The mixed olefins may comprise a combination of two or more kinds of olefin, or a combination of an olefin and a compound having a polyunsaturated bond such as a conjugated diene and a non-conjugated diene.

Examples of the α-olefin polymer produced according to the present invention are propylene homopolymer, 1-butene homopolymer, propylene-ethylene copolymer, propylene-1-butene copolymer, propylene-1-hexene copolymer and propylene-1-octene copolymer.

The process for producing an α-olefin polymer of the present invention is preferable for producing an isotactic stereoregular α-olefin polymer, and particularly preferable for producing an isotactic stereoregular propylene polymer.

Examples of the isotactic stereoregular propylene polymer are propylene homopolymers; random copolymers of propylene with ethylene and/or comonomers such as α-olefins having 4 to 12 carbon atoms, wherein ethylene and/or the comonomers are used in an amount, such that the obtained copolymers have a crystalline property; and a propylene-based copolymer obtained by homopolymerizing propylene, or copolymerizing propylene with ethylene or α-olefins having 4 to 12 carbon atoms, this polymerization step being hereinafter referred to as “former polymerization step”, and then copolymerizing α-olefins having 3 to 12 carbon atoms with ethylene in the presence of polymers produced in the former polymerization step, in a single step or multiple steps, this polymerization step being hereinafter referred to as “latter polymerization step”. The aforementioned “amount such that the obtained copolymers have a crystalline property” may vary depending on a kind of the copolymers. For example, when a comonomer is ethylene, ethylene is used in an amount so that the random copolymers to be obtained can contain the repeating units derived from ethylene in an amount of usually 10% by weight or less. When a comonomer is an α-olefin such as 1-butene, the α-olefin is used in an amount such that the obtained copolymers contain the repeating units derived from the α-olefin in an amount of usually 30% by weight or less, preferably 10% by weight or less. For the propylene-based copolymer, when the comonomer is ethylene, the copolymers produced in the former polymerization step contain ethylene units in an amount of usually 10% by weight or less, preferably 3% by weight or less, and further preferably 0.5% by weight or less, and when the comonomer is an α-olefin, the copolymers contain α-olefin units in an amount of usually 15% by weight or less, and preferably 10% by weight or less. The copolymers produced in the latter polymerization step contain ethylene units in an amount of usually 20 to 80% by weight, and preferably 30 to 50% by weight

The process for producing an olefin solid catalyst, comprising the following steps (i) and (ii), may be preferable;

step (i): polymerizing a small amount of an olefin in the presence of the solid catalyst component (A) and the organoaluminum compound (B) to form a catalyst component whose surface is covered by the resultant olefin polymers, this polymerization being generally referred to as “pre-polymerization” and the obtained catalyst components in the above pre-polymerization step being generally referred to as “pre-polymerized catalyst component”; and

step (ii): bringing the pre-polymerized catalyst component formed in the step (i), the organoaluminum compound (B) and the external electron donor (C) into contact with one another.

The olefin to be used in the above step (i) may be the same as, or different from an olefin to be used in the main polymerization. In addition, a chain-transfer agent such as hydrogen and/or the external electron donor (C) may be used in the pre-polymerization step (i).

The pre-polymerization is preferably a slurry polymerization using an inert hydrocarbon solvent such as propane, butane, isobutane, pentane, isopentane, hexane, heptane, octane, cyclohexane, benzene and toluene.

The organoaluminum compound (B) in the step (i) is used in an amount of usually 0.5 mol to 700 mol, preferably 0.8 mol to 500 mol, and particularly preferably 1 mol to 200 mol, per 1 mol of element of Group 4 of the periodic table which the solid catalyst component (A) to be used in the step (i) contains.

The olefin in the step (i) is pre-polymerized in an amount of usually 0.01 g to 1,000 g, preferably 0.05 g to 500 g, and particularly preferably 0.1 g to 200 g, per 1 g of the solid catalyst component (A) to be used in the step (i).

When the pre-polymerization of step (i) is a slurry polymerization, the slurry concentration of the solid catalyst component (A) is preferably 1 to 500 g-solid catalyst component/liter-solvent, and particularly preferably 3 to 300 g-solid catalyst component/liter-solvent.

The pre-polymerization is carried out at preferably −20° C. to 100° C., and particularly preferably 0° C. to 80° C., and under a partial pressure of an olefin in a gas phase of preferably 0.01 MPa to 2 MPa, and particularly preferably 0.1 MPa to 1 MPa, provided that an olefin in a liquid state under a pre-polymerization temperature and a pre-polymerization pressure is not limited thereto. The pre-polymerization time is preferably 2 minutes to 15 hours.

For example, in the pre-polymerization, the solid catalyst component (A), the organoaluminum compound (B) and the olefin may be supplied to a polymerization reactor according to the following method (1) or (2):

(1): a method in which the solid catalyst component (A) and the organoaluminum compound (B) are supplied, and then the olefin is supplied; or

(2): a method in which the solid catalyst component (A) and the olefin are supplied, and then the organoaluminum compound (B) is supplied.

For example, in the pre-polymerization, the olefin may be supplied to a polymerization reactor according to the following method (1) or (2):

(1): a method of sequentially feeding the olefin to the polymerization reactor, such that an inner pressure of the polymerization reactor is kept at a prescribed level; or

(2): a method of feeding a prescribed total amount of the olefin at the same time to the polymerization reactor.

The external electron donor (C) in the pre-polymerization is used in an amount of usually 0.01 mol to 400 mol, preferably 0.02 mol to 200 mol, and particularly preferably 0.03 mol to 100 mol, per 1 mol of element of Group 4 of the periodic table which the solid catalyst component (A) used in the pre-polymerization contains. In addition, it is used in an amount of usually 0.003 mol to 5 mol, preferably 0.005 mol to 3 mol, and particularly preferably 0.01 mol to 2 mol, per 1 mol of the organoaluminum compound (B) used in the pre-polymerization.

For example, in the pre-polymerization, the external electron donor (C) may be supplied to a polymerization reactor according to the following method (1) or (2):

(1): a method of feeding independently the external electron donor (C) to a pre-polymerization reactor; or

(2): a method of feeding a product obtained by bringing the external electron donor (C) into contact with the organoaluminum compound (B) to a pre-polymerization reactor.

The organoaluminum compound (B) in the main-polymerization is used in an amount of usually 1 mol to 1,000 mol, and particularly preferably 5 to 600 mol, per 1 mol of element of Group 4 of the periodic table which the solid catalyst component (A) used in the main-polymerization contains.

When the external electron donor (C) is used in the main-polymerization, it is used in an amount of usually 0.1 mol to 2,000 mol, preferably 0.3 mol to 1,000 mol, and particularly preferably 0.5 mol to 800 mol, per 1 mol of element of Group 4 of the periodic table which the solid catalyst component (A) used in the main-polymerization contains. In addition, it is used in an amount of usually 0.001 mol to 5 mol, preferably 0.005 mol to 3 mol, and particularly preferably 0.01 mol to 1 mol, per 1 mol of the organoaluminum compound (B) used in the main-polymerization.

The main-polymerization is carried out at usually −30° C. to 300° C., and preferably 20° C. to 180° C. The pressure of the main-polymerization is not particularly limited, but is usually an atmospheric pressure to 10 MPa, and preferably 200 kPa to 5 MPa, from an industrial and economical point of view. The main-polymerization can be carried out in a batchwise or continuous method. The main-polymerization may be a slurry or solution polymerization method using an inert hydrocarbon solvent such as propane, butane, isobutane, pentane, hexane, heptane and octane, a bulk polymerization method using as a medium an olefin which is liquid at a polymerization temperature, or a gas-phase polymerization method.

In order to control a molecular weight of polymers obtained in the main-polymerization, a chain-transfer agent, for example, hydrogen and an alkyl zinc such as dimethyl zinc and diethyl zinc may be used.

According to the present invention, an olefin polymerization solid catalyst having a sufficiently high polymerization activity and an ability to produce an olefin polymer with a low content of low-molecular weight components and amorphous components, and an olefin polymerization solid catalyst component used for producing the olefin polymerization solid catalyst can be provided. In addition, an olefin polymer with a low content of low-molecular weight components and amorphous components can be produced by using the olefin solid catalyst in the polymerization of an olefin. The present olefin polymerization solid catalyst component is useful as an isotactic stereoregular α-olefin polymerization catalyst.

### EXAMPLES

Hereinafter, the present invention will be described in more detail by way of Examples, but the present invention is not limited thereto.

### (Analysis of Catalyst)

The composition of solid catalyst components was analyzed by the following method.

The content of titanium atoms was determined as follows: a solid sample (about 20 mg) was decomposed with 2N diluted sulfuric acid (about 30 ml), and an excess of a 3% by weight aqueous hydrogen peroxide solution (3 ml) was added thereto to obtain a liquid sample; and the characteristic absorption of the liquid sample at 410 nm was measured with a double beam spectrophotometer, U-2001 model manufactured by Hitach, Ltd. and the content of titanium atoms was determined from an standard curve which had been separately created.

The alkoxy group content was determined as follows: the solid sample (about 2 g) was decomposed with water (100 ml) to obtain a liquid sample; and an amount of alcohol corresponding to the content of the alkoxy group in the liquid sample was determined with a gas chromatography internal standard method, and was then converted into the content of the alkoxy group.

The content of an internal electron donor was determined as follows: the solid catalyst component (about 300 mg) was dissolved in N,N-dimethylacetoamide (100 ml), and the content of the internal electron donor in the solution was determined with a gas chromatography internal standard method.

### (Analysis of Polymer)

### (1) Amount of Soluble Component in Xylene (CXS: % by Weight)

An amount of a soluble component of olefin polymer in xylene at 20° C. (hereinafter abbreviated to as “CXS”) was determined as follows: a polymer (1 g) was dissolved in boiled xylene (200 ml), and the resulting solution was gradually cooled to 50° C., and was then cooled to 20° C. while being stirred on ice water. After the solution was allowed to stand at 20° C. for 3 hours, the precipitated polymer was separated by filtration. The weight percentage of the polymer left in the filtrate was defined as CXS.

(2) Intrinsic Viscosity ([η]: dl/g)

Intrinsic viscosity of olefin polymer (hereinafter abbreviated to as “[η]”) was measured at 135° C. A tetralin solvent was used.

### Example 1

### (1) Synthesis of Olefin Polymerization Solid Catalyst Component Precursor

A separable flask equipped with a stirrer, which has a 500 ml of inner volume, was purged with nitrogen gas, and then was charged with 290 ml of hexane (solvent), 73 ml of tetraethoxysilane (silicon compound having a Si—O bond) and 2.5 ml of diisobutyl phthalate (organic acid ester) to form a mixture. The temperature in the flask was reduced to 5° C. while stirring the mixture. Then, 170 ml of dibutyl ether solution of butyl magnesium chloride (organomagnesium compound), whose concentration was 2.1 mol/l, was dropped into the flask, at a constant dropping rate over 4 hours while maintaining the temperature in the flask at 5° C. to obtain a reaction mixture. After the completion of the dropwise addition, the temperature of the reaction mixture was adjusted to 20° C. and stirred for 1 hour. A supernatant of the reaction mixture was removed by decantation to obtain a solid. The obtained solid was washed three times with 215 ml of toluene. After that, 215 ml of toluene was added to the washed solid. The resultant mixture was heated to 70° C. and stirred for 1 hour at the same temperature to obtain a solid catalyst component precursor slurry. A portion of the obtained slurry was sampled, and its composition was analyzed. The solid catalyst component precursor contained 27.5% by weight of ethoxy group. The content of the solid catalyst component precursor in the slurry (i.e., slurry concentration) was 0.154 g/ml.

### (2) Synthesis of Olefin Polymerization Solid Catalyst Component

After a 100 ml flask equipped with a stirrer, a dropping funnel and a thermometer was purged with a nitrogen gas, the slurry obtained in Example 1 (1) was added in the flask so that the amount of the solid catalyst component precursor could be 8.00 g. After that, 25.6 ml of toluene was removed from the slurry so that the slurry concentration could be 0.40 g-solid catalyst component precursor/ml-solvent. The temperature in the flask was adjusted to 10° C., and then a mixture of titanium tetrachloride (16 ml: metal halide compound) and dibutyl ether (0.8 ml), and 2.4 ml of ethyl 3-ethoxy-2-tert-butylpropionate (internal electron donor) were added thereto. After that, the temperature in the flask was elevated to 100° C., and the components in the flask were stirred for 3 hours at the same temperature. Subsequently, the obtained mixture was separated into a solid and a liquid. Then, the obtained solid was washed twice with 40 ml of toluene at 100° C., and 15 ml of toluene was added to the washed solid to form a slurry. And then, 16 ml of titanium tetrachloride and 0.8 ml of ethyl 3-ethoxy-2-tert-butylpropionate were added to the slurry, and the obtained mixture was stirred for 1 hour at 115° C. Afterward, the obtained mixture was separated into a solid and a liquid. Then, the obtained solid was washed twice with 40 ml of toluene at 115° C., and 15 ml of toluene was added to the washed solid to form a slurry. And then, 16 ml of titanium tetrachloride and 0.8 ml of ethyl 3-ethoxy-2-tert-butylpropionate were added to the slurry, and the obtained mixture was stirred for 1 hour at 100° C. Subsequently, the obtained mixture was separated into a solid and a liquid. After the obtained solid was washed three times with 40 ml of toluene at 100° C., and further washed three times with 40 ml of hexane at room temperature. The obtained solid was dried under a reduced pressure to obtain 7.81 g of olefin polymerization solid catalyst component in which the titanium content was 2.86% by weight. The analysis result was shown in Table 1.

### (3) Polymerization of Propylene

An autoclave equipped with a stirrer, which has a 3 L of inner volume, was completely dried and evacuated to be in vacuum. The autoclave was charged with 2.63 mmol of triethyl aluminum (organoaluminum compound), 0.26 mmol of cyclohexylethyldimethoxysilane (external electron donor) and 8.03 mg of the olefin polymerization solid catalyst component prepared in Example 1 (2). Subsequently, 780 g of propylene was added to the autoclave, and also hydrogen was charged thereto until the pressure reached 0.2 MPa. The temperature of the autoclave was elevated to 80° C., and propylene was polymerized for 1 hour at the same temperature. After completion of the polymerization reaction, an unreacted monomer was purged to obtain 256 g of propylene polymer. The yield of the polypropylene per the amount of titanium atoms in the catalyst (i.e., polymerization activity) was 1.1 ton-PP/g-Ti. As to this polypropylene, CXS was 1.1% by weight and [η] was 1.0 dl/g. The result was shown in Table 1.

### Comparative Example 1

### (1) Synthesis of Olefin Polymerization Solid Catalyst Component Precursor

A solid catalyst component precursor slurry was synthesized in the same manner as in Example 1 (1), except that 7.4 ml of tetrabutoxytitanium was used in addition to 290 ml of hexane, 73 ml of tetraethoxysilane and 2.5 ml of diisobutyl phthalate. A portion of the obtained slurry was sampled, and its composition was analyzed. The solid catalyst component precursor contained 1.93% by weight of titanium atom, 32.3% by weight of ethoxy group and 3.15% by weight of butoxy group. The content of the solid catalyst component precursor in the slurry (i.e., slurry concentration) was 0.187 g/ml.

### (2) Synthesis of Olefin Polymerization Solid Catalyst Component

The procedure of Example 1 (2) was repeated except that the solid catalyst component precursor obtained in Comparative Example 1 (1) was used as a solid catalyst component precursor, thereby obtaining 8.13 g of solid catalyst component. The titanium content thereof was 4.19% by weight. The analysis result was shown in Table 1.

### (3) Polymerization of Propylene

The procedure of Example 1 (3) was repeated except that 6.00 mg of the solid catalyst component obtained in Comparative Example 1 (2) was used as a solid catalyst component, thereby obtaining 178 g of propylene polymer. Polymerization activity was 0.71 ton-PP/g-Ti. As to this polypropylene, CXS was 1.4% by weight and [η] was 0.97 dl/g. The result was shown in Table 1.

### Example 2

### (1) Synthesis of Olefin Polymerization Solid Catalyst Component

After a 100 ml flask equipped with a stirrer, a dropping funnel and a thermometer was purged with a nitrogen gas, the slurry obtained in Example 1 (1) was added in the flask so that the amount of the solid catalyst component precursor could be 8.00 g. After that, 25.6 ml of toluene was removed from the slurry so that the slurry concentration could be 0.40 g-solid catalyst component precursor/ml-solvent. The temperature in the flask was adjusted to 20° C., and then 4.8 ml of ethyl 3-ethoxy-2-tert-butylpropionate was added thereto. After that, the temperature in the flask was elevated to 100° C., and the components in the flask were stirred for 30 minutes at the same temperature. Subsequently, the obtained mixture was separated into a solid and a liquid. Then, the obtained solid was washed twice with 40 ml of toluene at 100° C., and 15 ml of toluene was added to the washed solid to form a slurry. And then, a mixture of 16 ml of titanium tetrachloride and 0.8 ml of dibutyl ether, and 2.4 ml of ethyl 3-ethoxy-2-tert-butylpropionate were added to the slurry, and the obtained mixture was stirred for 3 hours at 115° C. Afterward, the obtained mixture was separated into a solid and a liquid. Then, the obtained solid was washed twice with 40 ml of toluene at 115° C., and 15 ml of toluene was added to the washed solid to form a slurry. And then, a mixture of 16 ml of titanium tetrachloride and 0.8 ml of dibutyl ether, and 0.8 ml of ethyl 3-ethoxy-2-tert-butylpropionate were added to the slurry, and the obtained mixture was stirred for 1 hour at 115° C. Subsequently, the obtained mixture was separated into a solid and a liquid. Then, the obtained solid was washed twice with 40 ml of toluene at 115° C., and 15 ml of toluene was added to the washed solid to form a slurry. A mixture of 16 ml of titanium tetrachloride and 0.8 ml of dibutyl ether, and 0.4 ml of ethyl 3-ethoxy-2-tert-butylpropionate were added to the slurry, and then the obtained mixture was stirred for 1 hour at 115° C. Then, the obtained mixture was separated into a solid and a liquid. After the obtained solid was washed three times with 40 ml of toluene at 115° C., and further washed three times with 40 ml of hexane at room temperature. The obtained solid was dried under a reduced pressure to obtain 6.50 g of olefin polymerization solid catalyst component in which the titanium content was 1.44% by weight. The analysis result was shown in Table 1.

### (2) Polymerization of Propylene

The procedure of Example 1 (3) was repeated except that 5.99 mg of the solid catalyst component obtained in Example 2 (1) was used as a solid catalyst component, thereby obtaining 244 g of propylene polymer. Polymerization activity was 2.8 ton-PP/g-Ti. As to this polypropylene, CXS was 0.94% by weight and [η] was 1.1 dl/g. The result was shown in Table 1.

### Comparative Example 2

### (1) Synthesis of Olefin Polymerization Solid Catalyst Component

The procedure of Example 2 (1) was repeated except that the solid catalyst component precursor obtained in Comparative Example 1 (1) was used as a solid catalyst component precursor, thereby obtaining 6.28 g of solid catalyst component. The titanium content thereof was 2.18% by weight. The analysis result was shown in Table 1.

### (2) Polymerization of Propylene

The procedure of Example 1 (3) was repeated except that 5.57 mg of the solid catalyst component obtained in Comparative Example 2 (1) was used as a solid catalyst component, thereby obtaining 174 g of propylene polymer. Polymerization activity was 1.4 ton-PP/g-Ti. As to this polypropylene, CXS was 1.3% by weight and [η] was 0.97 dl/g. The result was shown in Table 1.

### Example 3

### (1) Synthesis of Olefin Polymerization Solid Catalyst Component Precursor

A solid catalyst component precursor slurry was synthesized in the same manner as in Example 1 (1), except that the amount of tetraethoxysilane was changed to 88.5 ml, the amount of diisobutyl phthalate was changed to 2.1 ml, and the amount of dibutyl ether solution of butyl magnesium chloride was changed to 192 ml. A portion of the obtained slurry was sampled, and its composition was analyzed. The solid catalyst component precursor contained 30.0% by weight of ethoxy group. The content of the solid catalyst component precursor in the slurry (i.e., slurry concentration) was 0.178 g/ml.

### (2) Synthesis of Olefin Polymerization Solid Catalyst Component

The procedure of Example 2 (1) was repeated except that the solid catalyst component precursor obtained in Example 3 (1) was used as a solid catalyst component precursor, thereby obtaining 6.74 g of solid catalyst component. The titanium content thereof was 1.53% by weight. The analysis result was shown in Table 1.

### (3) Polymerization of Propylene

The procedure of Example 1 (3) was repeated except that 10.75 mg of the solid catalyst component obtained in Example 3 (2) was used as a solid catalyst component, thereby obtaining 399 g of propylene polymer. Polymerization activity was 2.4 ton-PP/g-Ti. As to this polypropylene, CXS was 1.1% by weight and [η] was 1.0 dl/g. The result was shown in Table 1.

### Example 4

### (1) Synthesis of Olefin Polymerization Solid Catalyst Component Precursor

A solid catalyst component precursor slurry was synthesized in the same manner as in Example 1 (1), except that the amount of tetraethoxysilane was changed to 88.5 ml, the amount of diisobutyl phthalate was changed to 3.9 ml, and the amount of dibutyl ether solution of butyl magnesium chloride was changed to 196 ml. A portion of the obtained slurry was sampled, and its composition was analyzed. The solid catalyst component precursor contained 25.4% by weight of ethoxy group. The content of the solid catalyst component precursor in the slurry (i.e., slurry concentration) was 0.170 g/ml.

### (2) Synthesis of Olefin Polymerization Solid Catalyst Component

The procedure of Example 2 (1) was repeated except that the solid catalyst component precursor obtained in Example 4 (1) was used as a solid catalyst component precursor, thereby obtaining 6.72 g of solid catalyst component. The titanium content thereof was 1.42% by weight. The analysis result was shown in Table 1.

### (3) Polymerization of Propylene

The procedure of Example 1 (3) was repeated except that 7.73 mg of the solid catalyst component obtained in Example 4 (2) was used as a solid catalyst component, thereby obtaining 290 g of propylene polymer. Polymerization activity was 2.6 ton-PP/g-Ti. As to this polypropylene, CXS was 0.97% by weight and [η] was 0.99 dl/g. The result was shown in Table 1 and Table 2.

### Comparative Example 3

### (1) Synthesis of Olefin Polymerization Solid Catalyst Component

After a 100 ml flask equipped with a stirrer, a dropping funnel and a thermometer was purged with a nitrogen gas, the slurry obtained in Example 4 (1) was added in the flask so that the amount of the solid catalyst component precursor could be 8.00 g. After that, 20.7 ml of toluene was removed from the slurry so that the slurry concentration could be 0.40 g-solid catalyst component precursor/ml-solvent. The temperature in the flask was adjusted to 20° C., and then 4.8 g of diphenyl phthalate was added thereto. After that, the temperature in the flask was elevated to 100° C., and the components in the flask were stirred for 30 minutes at the same temperature. Subsequently, the obtained mixture was separated into a solid and a liquid. Then, the obtained solid was washed twice with 40 ml of toluene at 100° C., and 15 ml of toluene was added to the washed solid to form a slurry. And then, a mixture of 16 ml of titanium tetrachloride and 0.8 ml of dibutyl ether, and 2.4 g of diphenyl phthalate were added to the slurry, and the obtained mixture was stirred for 3 hours at 115° C. After that, the obtained mixture was separated into a solid and a liquid. Then, the obtained solid was washed twice with 40 ml of toluene at 115° C., and 15 ml of toluene was added to the washed solid to form a slurry. And then, a mixture of 16 ml of titanium tetrachloride and 0.8 ml of dibutyl ether, and 0.8 g of diphenyl phthalate were added to the slurry, and the obtained mixture was stirred for 1 hour at 115° C. Subsequently, the obtained mixture was separated into a solid and a liquid. Then, the obtained solid was washed twice with 40 ml of toluene at 115° C., and 15 ml of toluene was added to the washed solid to form a slurry. A mixture of 16 ml of titanium tetrachloride and 0.8 ml of dibutyl ether, and 0.4 g of diphenyl phthalate were added to the slurry, and then the obtained mixture was stirred for 1 hour at 115° C. Then, the obtained mixture was separated into a solid and a liquid. After the obtained solid was washed three times with 40 ml of toluene at 115° C., and further washed three times with 40 ml of hexane at room temperature. The obtained solid was dried under a reduced pressure to obtain 7.85 g of olefin polymerization solid catalyst component in which the titanium content was 2.63% by weight. The analysis result was shown in Table 1.

### (3) Polymerization of Propylene

The procedure of Example 1 (3) was repeated except that 4.99 mg of the solid catalyst component obtained in Comparative Example 3 (1) was used as a solid catalyst component, thereby obtaining 103 g of propylene polymer. Polymerization activity was 0.78 ton-PP/g-Ti. As to this polypropylene, CXS was 1.1% by weight and [η] was 1.1 dl/g. The result was shown in Table 1.

### Example 5

### (1) Synthesis of Olefin Polymerization Solid Catalyst Component

After a 100 ml flask equipped with a stirrer, a dropping funnel and a thermometer was purged with a nitrogen gas, the slurry obtained in Example 3 (1) was added in the flask so that the amount of the solid catalyst component precursor could be 8.00 g. After that, 18.4 ml of toluene was removed from the slurry so that the slurry concentration could be 0.40 g-solid catalyst component precursor/ml-solvent. The temperature in the flask was adjusted to 20° C., and then 4.8 ml of ethyl 3-ethoxy-2-tert-butylpropionate was added thereto. After that, the temperature in the flask was elevated to 100° C., and the components in the flask were stirred for 30 minutes at the same temperature. Subsequently, the obtained mixture was separated into a solid and a liquid. Then, the obtained solid was washed twice with 40 ml of toluene at 100° C., and 15 ml of toluene was added to the washed solid to form a slurry. And then, a mixture of 16 ml of titanium tetrachloride and 0.8 ml of dibutyl ether, and 2.4 ml of ethyl 3-ethoxy-2-tert-butylpropionate were added to the slurry, and the obtained mixture was stirred for 3 hours at 115° C. After that, the obtained mixture was separated into a solid and a liquid. Then, the obtained solid was washed twice with 40 ml of toluene at 115° C., and 15 ml of toluene was added to the washed solid to form a slurry. And then, a mixture of 16 ml of titanium tetrachloride and 0.8 ml of dibutyl ether, and 0.8 ml of ethyl 3-ethoxy-2-tert-butylpropionate were added to the slurry, and the obtained mixture was stirred for 1 hour at 115° C. Subsequently, the obtained mixture was separated into a solid and a liquid. Then, the obtained solid was washed twice with 40 ml of toluene at 115° C., and 15 ml of toluene was added to the washed solid to form a slurry. A mixture of 16 ml of titanium tetrachloride and 0.8 ml of dibutyl ether was added to the slurry, and then the obtained mixture was stirred for 1 hour at 115° C. Then, the obtained mixture was separated into a solid and a liquid. After the obtained solid was washed three times with 40 ml of toluene at 115° C., and further washed three times with 40 ml of hexane at room temperature. The obtained solid was dried under a reduced pressure to obtain 6.85 g of olefin polymerization solid catalyst component in which the titanium content was 1.66% by weight. The analysis result was shown in Table 1.

### (2) Polymerization of Propylene

The procedure of Example 1 (3) was repeated except that 6.10 mg of the solid catalyst component obtained in Example 5 (1) was used as a solid catalyst component, thereby obtaining 233 g of propylene polymer. Polymerization activity was 2.3 ton-PP/g-Ti. As to this polypropylene, CXS was 1.2% by weight and [η] was 1.0 dl/g. The result was shown in Table 1.

### Example 6

### (1) Synthesis of Olefin Polymerization Solid Catalyst Component

After a 100 ml flask equipped with a stirrer, a dropping funnel and a thermometer was purged with a nitrogen gas, the slurry obtained in Example 3 (1) was added in the flask so that the amount of the solid catalyst component precursor could be 8.00 g. After that, 18.4 ml of toluene was removed from the slurry so that the slurry concentration could be 0.40 g-solid catalyst component precursor/ml-solvent. The temperature in the flask was adjusted to 20° C., and then 4.8 ml of ethyl 3-ethoxy-2-tert-butylpropionate was added thereto. After that, the temperature in the flask was elevated to 100° C., and the components in the flask were stirred for 30 minutes at the same temperature. Subsequently, the obtained mixture was separated into a solid and a liquid. Then, the obtained solid was washed twice with 40 ml of toluene at 100° C., and 15 ml of toluene was added to the washed solid to form a slurry. And then, a mixture of 16 ml of titanium tetrachloride and 0.8 ml of dibutyl ether, and 2.4 ml of ethyl 3-ethoxy-2-tert-butylpropionate were added to the slurry, and the obtained mixture was stirred for 3 hours at 115° C. After that, the obtained mixture was separated into a solid and a liquid. The obtained solid was washed twice with 40 ml of toluene at 115° C., and then 15 ml of toluene was added to the washed solid to form a slurry. Then, a mixture of 16 ml of titanium tetrachloride and 0.8 ml of dibutyl ether was added to the slurry, and the obtained mixture was stirred for 1 hour at 115° C. Subsequently, the obtained mixture was separated into a solid and a liquid. Then, the obtained solid was washed twice with 40 ml of toluene at 115° C., and 15 ml of toluene was added to the washed solid to form a slurry. A mixture of 16 ml of titanium tetrachloride and 0.8 ml of dibutyl ether was added to the slurry, and then the obtained mixture was stirred for 1 hour at 115° C. Then, the obtained mixture was separated into a solid and a liquid. After the obtained solid was washed three times with 40 ml of toluene at 115° C., and further washed three times with 40 ml of hexane at room temperature. The obtained solid was dried under a reduced pressure to obtain 6.85 g of olefin polymerization solid catalyst component in which the titanium content was 1.92% by weight. The analysis result was shown in Table 1.

### (2) Polymerization of Propylene

The procedure of Example 1 (3) was repeated except that 5.79 mg of the solid catalyst component obtained in Example 6 (1) was used as a solid catalyst component, thereby obtaining 175 g of propylene polymer. Polymerization activity was 1.6 ton-PP/g-Ti. As to this polypropylene, CXS was 1.5% by weight and [η] was 1.0 dl/g. The result was shown in Table 1.

TABLE 1

| | | compositional | | | | | |
|---|---|---|---|---|---|---|---|
| | | analysis result | | | | | |
| | | | | internal | | | |
| | synthesis condition | | ethoxy | electron | polymerization result | | |
| | of the solid | titanium | group | donor | activity | | |
| | catalyst component (A) | content | content | content | (ton-PP/ | CXS | [η] |
| | internal electron donor | (wt %) | (wt %) | (wt %) | g-Ti) | (wt %) | (dl/g) |
| Example 1 | A | 2.86 | 0.16 | 15.7 | 1.1 | 1.1 | 1.0 |
| Comparative | A | 4.19 | 0.14 | 18.3 | 0.71 | 1.4 | 0.97 |
| Example 1 | | | | | | | |
| Example 2 | A | 1.44 | 0.25 | 7.5 | 2.8 | 0.94 | 1.1 |
| Comparative | A | 2.18 | 0.30 | 9.7 | 1.4 | 1.3 | 0.97 |
| Example 2 | | | | | | | |
| Example 3 | A | 1.53 | 0.37 | 7.9 | 2.4 | 1.1 | 1.0 |
| Example 4 | A | 1.42 | 0.36 | 6.9 | 2.6 | 0.97 | 0.99 |
| Comparative | B | 2.63 | 0.48 | 12.2 | 0.78 | 1.1 | 1.1 |
| Example 3 | | | | | | | |
| Example 5 | A | 1.66 | 0.26 | 6.4 | 2.3 | 1.2 | 1.0 |
| Example 6 | A | x | 0.27 | 5.9 | 1.6 | 1.5 | 1.0 |

A: ethyl 3-ethoxy-2-tert-butylpropionate
B: diphenyl phthalate

### Example 7

### (1) Synthesis of Olefin Polymerization Solid Catalyst Component Precursor

A solid catalyst component precursor slurry was synthesized in the same manner as in Example 1 (1), except that 1.7 ml of diethyl malonate was used instead of 2.5 ml of diisobutyl phthalate, the amount of tetraethoxysilane was changed to 91 ml, and the amount of dibutyl ether solution of butyl magnesium chloride was changed to 199 ml. A portion of the obtained slurry was sampled, and its composition was analyzed. The solid catalyst component precursor contained 25.5% by weight of ethoxy group. The content of the solid catalyst component precursor in the slurry (i.e., slurry concentration) was 0.180 g/ml.

### (2) Synthesis of Olefin Polymerization Solid Catalyst Component

The procedure of Example 2 (1) was repeated except that the solid catalyst component precursor obtained in Example 7 (1) was used as a solid catalyst component precursor, thereby obtaining 6.6 g of solid catalyst component. The titanium content thereof was 1.40% by weight.

### (3) Polymerization of Propylene

The procedure of Example 1 (3) was repeated except that 6.79 mg of the solid catalyst component obtained in Example 7 (2) was used as a solid catalyst component, thereby obtaining 227 g of propylene polymer. Polymerization activity was 2.4 ton-PP/g-Ti. As to this polypropylene, CXS was 1.1% by weight and [η] was 0.95 dl/g. The result was shown in Table 2.

### Example 8

### (1) Synthesis of Olefin Polymerization Solid Catalyst Component Precursor

A solid catalyst component precursor slurry was synthesized in the same manner as in Example 1 (1), except that 2.5 ml of diethyl 2,2-diethylmalonate was used instead of 2.5 ml of diisobutyl phthalate, the amount of tetraethoxysilane was changed to 91 ml, and the amount of dibutyl ether solution of butyl magnesium chloride was changed to 199 ml. A portion of the obtained slurry was sampled, and its composition was analyzed. The solid catalyst component precursor contained 20.8% by weight of ethoxy group. The content of the solid catalyst component precursor in the slurry (i.e., slurry concentration) was 0.178 g/ml.

### (2) Synthesis of Olefin Polymerization Solid Catalyst Component

The procedure of Example 2 (1) was repeated except that the solid catalyst component precursor obtained in Example 8 (1) was used as a solid catalyst component precursor, thereby obtaining 6.4 g of solid catalyst component. The titanium content thereof was 1.49% by weight.

### (3) Polymerization of Propylene

The procedure of Example 1 (3) was repeated except that 6.09 mg of the solid catalyst component obtained in Example 8 (2) was used as a solid catalyst component, thereby obtaining 173 g of propylene polymer. Polymerization activity was 1.9 ton-PP/g-Ti. As to this polypropylene, CXS was 1.1% by weight and [η] was 0.92 dl/g. The result was shown in Table 2.

### Example 9

### (1) Synthesis of Olefin Polymerization Solid Catalyst Component Precursor

A solid catalyst component precursor slurry was synthesized in the same manner as in Example 1 (1), except that 5.5 ml of di(2-ethylhexyl) dodecanedioate was used instead of 2.5 ml of diisobutyl phthalate, the amount of tetraethoxysilane was changed to 91 ml, and the amount of dibutyl ether solution of butyl magnesium chloride was changed to 199 ml. A portion of the obtained slurry was sampled, and its composition was analyzed. The solid catalyst component precursor contained 22.4% by weight of ethoxy group. The content of the solid catalyst component precursor in the slurry (i.e., slurry concentration) was 0.195 g/ml.

### (2) Synthesis of Olefin Polymerization Solid Catalyst Component

The procedure of Example 2 (1) was repeated except that the solid catalyst component precursor obtained in Example 9 (1) was used as a solid catalyst component precursor, thereby obtaining 7.1 g of solid catalyst component. The titanium content thereof was 1.57% by weight.

### (3) Polymerization of Propylene

The procedure of Example 1 (3) was repeated except that 6.56 mg of the solid catalyst component obtained in Example 9 (2) was used as a solid catalyst component, thereby obtaining 238 g of propylene polymer. Polymerization activity was 2.3 ton-PP/g-Ti. As to this polypropylene, CXS was 1.1% by weight and [η] was 0.97 dl/g. The result was shown in Table 2.

### Example 10

### (1) Synthesis of Olefin Polymerization Solid Catalyst Component Precursor

A solid catalyst component precursor slurry was synthesized in the same manner as in Example 1 (1), except that 2.4 ml of diethyl cyclohexane-1,2-dicarboxylate was used instead of 2.5 ml of diisobutyl phthalate, the amount of tetraethoxysilane was changed to 91 ml, and the amount of dibutyl ether solution of butyl magnesium chloride was changed to 199 ml. A portion of the obtained slurry was sampled, and its composition was analyzed. The solid catalyst component precursor contained 18.5% by weight of ethoxy group. The content of the solid catalyst component precursor in the slurry (i.e., slurry concentration) was 0.181 g/ml.

### (2) Synthesis of Olefin Polymerization Solid Catalyst Component

The procedure of Example 2 (1) was repeated except that the solid catalyst component precursor obtained in Example 10 (1) was used as a solid catalyst component precursor, thereby obtaining 7.0 g of solid catalyst component. The titanium content thereof was 1.58% by weight.

### (3) Polymerization of Propylene

The procedure of Example 1 (3) was repeated except that 3.60 mg of the solid catalyst component obtained in Example 10 (2) was used as a solid catalyst component, thereby obtaining 110 g of propylene polymer. Polymerization activity was 1.9 ton-PP/g-Ti. As to this polypropylene, CXS was 1.1% by weight and [η] was 0.90 dl/g. The result was shown in Table 2.

### Example 11

### (1) Synthesis of Olefin Polymerization Solid Catalyst Component Precursor

A solid catalyst component precursor slurry was synthesized in the same manner as in Example 1 (1), except that 3.1 ml of ethyl benzoate was used instead of 2.5 ml of diisobutyl phthalate, the amount of tetraethoxysilane was changed to 88.5 ml, and the amount of dibutyl ether solution of butyl magnesium chloride was changed to 199 ml. A portion of the obtained slurry was sampled, and its composition was analyzed. The solid catalyst component precursor contained 22.9% by weight of ethoxy group. The content of the solid catalyst component precursor in the slurry (i.e., slurry concentration) was 0.179 g/ml.

### (2) Synthesis of Olefin Polymerization Solid Catalyst Component

The procedure of Example 2 (1) was repeated except that the solid catalyst component precursor obtained in Example 11 (1) was used as a solid catalyst component precursor, thereby obtaining 6.9 g of solid catalyst component. The titanium content thereof was 1.59% by weight.

### (3) Polymerization of Propylene

The procedure of Example 1 (3) was repeated except that 7.81 mg of the solid catalyst component obtained in Example 11 (2) was used as a solid catalyst component, thereby obtaining 394 g of propylene polymer. Polymerization activity was 3.2 ton-PP/g-Ti. As to this polypropylene, CXS was 1.1% by weight and [η] was 1.0 dl/g. The result was shown in Table 2.

### Example 12

### (1) Synthesis of Olefin Polymerization Solid Catalyst Component Precursor

A solid catalyst component precursor slurry was synthesized in the same manner as in Example 1 (1), except that 3.8 ml of butyl benzoate was used instead of 2.5 ml of diisobutyl phthalate, the amount of tetraethoxysilane was changed to 88.5 ml, and the amount of dibutyl ether solution of butyl magnesium chloride was changed to 199 ml. A portion of the obtained slurry was sampled, and its composition was analyzed. The solid catalyst component precursor contained 20.6% by weight of ethoxy group. The content of the solid catalyst component precursor in the slurry (i.e., slurry concentration) was 0.173 g/ml.

### (2) Synthesis of Olefin Polymerization Solid Catalyst Component

The procedure of Example 2 (1) was repeated except that the solid catalyst component precursor obtained in Example 12 (1) was used as a solid catalyst component precursor, thereby obtaining 7.0 g of solid catalyst component. The titanium content thereof was 1.56% by weight.

### (3) Polymerization of Propylene

The procedure of Example 1 (3) was repeated except that 6.72 mg of the solid catalyst component obtained in Example 12 (2) was used as a solid catalyst component, thereby obtaining 356 g of propylene polymer. Polymerization activity was 3.4 ton-PP/g-Ti. As to this polypropylene, CXS was 0.89% by weight and [η] was 1.0 dl/g. The result was shown in Table 2.

### Example 13

### (1) Synthesis of Olefin Polymerization Solid Catalyst Component Precursor

A solid catalyst component precursor slurry was synthesized in the same manner as in Example 1 (1), except that 4.2 ml of amyl benzoate was used instead of 2.5 ml of diisobutyl phthalate, the amount of tetraethoxysilane was changed to 88.5 ml, and the amount of dibutyl ether solution of butyl magnesium chloride was changed to 199 ml. A portion of the obtained slurry was sampled, and its composition was analyzed. The solid catalyst component precursor contained 30.3% by weight of ethoxy group. The content of the solid catalyst component precursor in the slurry (i.e., slurry concentration) was 0.171 g/ml.

### (2) Synthesis of Olefin Polymerization Solid Catalyst Component

The procedure of Example 2 (1) was repeated except that the solid catalyst component precursor obtained in Example 13 (1) was used as a solid catalyst component precursor, thereby obtaining 6.9 g of solid catalyst component. The titanium content thereof was 1.47% by weight.

### (3) Polymerization of Propylene

The procedure of Example 1 (3) was repeated except that 7.01 mg of the solid catalyst component obtained in Example 13 (2) was used as a solid catalyst component, thereby obtaining 301 g of propylene polymer. Polymerization activity was 2.9 ton-PP/g-Ti. As to this polypropylene, CXS was 1.0% by weight and [η] was 1.0 dl/g. The result was shown in Table 2.

### Example 14

### (1) Synthesis of Olefin Polymerization Solid Catalyst Component Precursor

A solid catalyst component precursor slurry was synthesized in the same manner as in Example 1 (1), except that 4.6 ml of n-hexyl benzoate was used instead of 2.5 ml of diisobutyl phthalate, the amount of tetraethoxysilane was changed to 88.5 ml, and the amount of dibutyl ether solution of butyl magnesium chloride was changed to 199 ml. A portion of the obtained slurry was sampled, and its composition was analyzed. The solid catalyst component precursor contained 23.2% by weight of ethoxy group. The content of the solid catalyst component precursor in the slurry (i.e., slurry concentration) was 0.172 g/ml.

### (2) Synthesis of Olefin Polymerization Solid Catalyst Component

The procedure of Example 2 (1) was repeated except that the solid catalyst component precursor obtained in Example 14 (1) was used as a solid catalyst component precursor, thereby obtaining 6.7 g of solid catalyst component. The titanium content thereof was 1.49% by weight.

### (3) Polymerization of Propylene

The procedure of Example 1 (3) was repeated except that 8.55 mg of the solid catalyst component obtained in Example 14 (2) was used as a solid catalyst component, thereby obtaining 386 g of propylene polymer. Polymerization activity was 3.0 ton-PP/g-Ti. As to this polypropylene, CXS was 1.0% by weight and [η] was 1.0 dl/g. The result was shown in Table 2.

### Example 15

### (1) Synthesis of Olefin Polymerization Solid Catalyst Component Precursor

A solid catalyst component precursor slurry was synthesized in the same manner as in Example 1 (1), except that 3.5 ml of isopropyl benzoate was used instead of 2.5 ml of diisobutyl phthalate, the amount of tetraethoxysilane was changed to 88.5 ml, and the amount of dibutyl ether solution of butyl magnesium chloride was changed to 199 ml. A portion of the obtained slurry was sampled, and its composition was analyzed. The solid catalyst component precursor contained 36.6% by weight of ethoxy group. The content of the solid catalyst component precursor in the slurry (i.e., slurry concentration) was 0.191 g/ml.

### (2) Synthesis of Olefin Polymerization Solid Catalyst Component

The procedure of Example 2 (1) was repeated except that the solid catalyst component precursor obtained in Example 15 (1) was used as a solid catalyst component precursor, thereby obtaining 6.6 g of solid catalyst component. The titanium content thereof was 1.45% by weight.

### (3) Polymerization of Propylene

The procedure of Example 1 (3) was repeated except that 7.21 mg of the solid catalyst component obtained in Example 15 (2) was used as a solid catalyst component, thereby obtaining 283 g of propylene polymer. Polymerization activity was 2.7 ton-PP/g-Ti. As to this polypropylene, CXS was 1.0% by weight and [η] was 0.97 dl/g. The result was shown in Table 2.

### Example 16

### (1) Synthesis of Olefin Polymerization Solid Catalyst Component Precursor

A solid catalyst component precursor slurry was synthesized in the same manner as in Example 1 (1), except that 3.9 ml of isobutyl benzoate was used instead of 2.5 ml of diisobutyl phthalate, the amount of tetraethoxysilane was changed to 88.5 ml, and the amount of dibutyl ether solution of butyl magnesium chloride was changed to 199 ml. A portion of the obtained slurry was sampled, and its composition was analyzed. The solid catalyst component precursor contained 27.9% by weight of ethoxy group. The content of the solid catalyst component precursor in the slurry (i.e., slurry concentration) was 0.177 g/ml.

### (2) Synthesis of Olefin Polymerization Solid Catalyst Component

The procedure of Example 2 (1) was repeated except that the solid catalyst component precursor obtained in Example 16 (1) was used as a solid catalyst component precursor, thereby obtaining 7.0 g of solid catalyst component. The titanium content thereof was 1.46% by weight.

### (3) Polymerization of Propylene

The procedure of Example 1 (3) was repeated except that 8.31 mg of the solid catalyst component obtained in Example 16 (2) was used as a solid catalyst component, thereby obtaining 336 g of propylene polymer. Polymerization activity was 2.8 ton-PP/g-Ti. As to this polypropylene, CXS was 0.90% by weight and [η] was 0.99 dl/g. The result was shown in Table 2.

### Example 17

### (1) Synthesis of Olefin Polymerization Solid Catalyst Component Precursor

A solid catalyst component precursor slurry was synthesized in the same manner as in Example 1 (1), except that 3.4 ml of ethyl 3-ethoxypropionate was used instead of 2.5 ml of diisobutyl phthalate, the amount of tetraethoxysilane was changed to 88.5 ml, and the amount of dibutyl ether solution of butyl magnesium chloride was changed to 199 ml. A portion of the obtained slurry was sampled, and its composition was analyzed. The solid catalyst component precursor contained 25.5% by weight of ethoxy group. The content of the solid catalyst component precursor in the slurry (i.e., slurry concentration) was 0.164 g/ml.

### (2) Synthesis of Olefin Polymerization Solid Catalyst Component

The procedure of Example 2 (1) was repeated except that the solid catalyst component precursor obtained in Example 17 (1) was used as a solid catalyst component precursor, thereby obtaining 6.6 g of solid catalyst component. The titanium content thereof was 1.57% by weight.

### (3) Polymerization of Propylene

The procedure of Example 1 (3) was repeated except that 5.96 mg of the solid catalyst component obtained in Example 17 (2) was used as a solid catalyst component, thereby obtaining 316 g of propylene polymer. Polymerization activity was 3.4 ton-PP/g-Ti. As to this polypropylene, CXS was 1.0% by weight and [η] was 0.96 dl/g. The result was shown in Table 2.

### Example 18

### (1) Synthesis of Olefin Polymerization Solid Catalyst Component Precursor

A solid catalyst component precursor slurry was synthesized in the same manner as in Example 1 (1), except that 1.9 ml of butyl levulinate was used instead of 2.5 ml of diisobutyl phthalate, the amount of tetraethoxysilane was changed to 91 ml, and the amount of dibutyl ether solution of butyl magnesium chloride was changed to 199 ml. A portion of the obtained slurry was sampled, and its composition was analyzed. The solid catalyst component precursor contained 35.2% by weight of ethoxy group. The content of the solid catalyst component precursor in the slurry (i.e., slurry concentration) was 0.179 g/ml.

### (2) Synthesis of Olefin Polymerization Solid Catalyst Component

The procedure of Example 2 (1) was repeated except that the solid catalyst component precursor obtained in Example 18 (1) was used as a solid catalyst component precursor, thereby obtaining 6.9 g of solid catalyst component. The titanium content thereof was 1.62% by weight.

### (3) Polymerization of Propylene

The procedure of Example 1 (3) was repeated except that 6.12 mg of the solid catalyst component obtained in Example 18 (2) was used as a solid catalyst component, thereby obtaining 291 g of propylene polymer. Polymerization activity was 2.9 ton-PP/g-Ti. As to this polypropylene, CXS was 0.9% by weight and [η] was 1.0 dl/g. The result was shown in Table 2.

### Example 19

### (1) Synthesis of Olefin Polymerization Solid Catalyst Component Precursor

A solid catalyst component precursor slurry was synthesized in the same manner as in Example 1 (1), except that 1.8 ml of diethyl succinate was used instead of 2.5 ml of diisobutyl phthalate, the amount of tetraethoxysilane was changed to 91 ml, and the amount of dibutyl ether solution of butyl magnesium chloride was changed to 199 ml. A portion of the obtained slurry was sampled, and its composition was analyzed. The solid catalyst component precursor contained 27.0% by weight of ethoxy group. The content of the solid catalyst component precursor in the slurry (i.e., slurry concentration) was 0.180 g/ml.

### (2) Synthesis of Olefin Polymerization Solid Catalyst Component

The procedure of Example 2 (1) was repeated except that the solid catalyst component precursor obtained in Example 19 (1) was used as a solid catalyst component precursor, thereby obtaining 7.0 g of solid catalyst component. The titanium content thereof was 1.62% by weight.

### (3) Polymerization of Propylene

The procedure of Example 1 (3) was repeated except that 4.04 mg of the solid catalyst component obtained in Example 19 (2) was used as a solid catalyst component, thereby obtaining 187 g of propylene polymer. Polymerization activity was 2.9 ton-PP/g-Ti. As to this polypropylene, CXS was 1.1% by weight and [η] was 0.94 dl/g. The result was shown in Table 2.

TABLE 2

| | | | activity | | |
|---|---|---|---|---|---|
| | | | (ton-PP/ | CXS | [η] |
| | organic acid ester (C) | | g-Ti) | (wt %) | (dl/g) |
| Example 4 | diisobutyl phthalate | 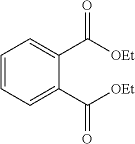 [SMILES: CCOC(=O)c1ccccc1C(=O)OCC] | 2.6 | 0.97 | 0.99 |
| Example 7 | diethyl malonate | 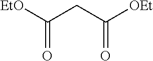 [SMILES: CCOC(=O)CC(=O)OCC] | 2.4 | 1.1 | 0.95 |
| Example 8 | diethyl 2,2-diethylmalonate | 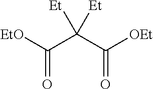 [SMILES: CCOC(=O)C(CC)(CC)C(=O)OCC] | 1.9 | 1.1 | 0.92 |
| Example 9 | di(2-ethylhexyl) dodecanedioate | 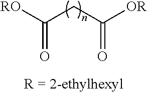 | 2.3 | 1.1 | 0.97 |
| Example 10 | diethyl cyclohexane-1,2-dicarboxylate | 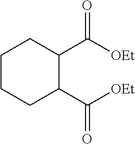 [SMILES: CCOC(=O)C1CCCCC1C(=O)OCC] | 1.9 | 1.1 | 0.90 |
| Example 11 | ethyl benzoate | 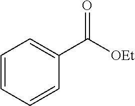 [SMILES: CCOC(=O)c1ccccc1] | 3.2 | 1.1 | 1.0 |
| Example 12 | butyl benzoate | 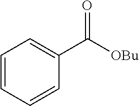 | 3.4 | 0.89 | 1.0 |
| Example 13 | amyl benzoate | 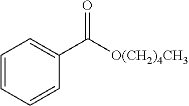 | 2.9 | 1.0 | 1.0 |
| Example 14 | n-hexyl benzoate | 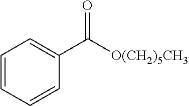 | 3.0 | 1.0 | 1.0 |
| Example 15 | isopropyl benzoate | 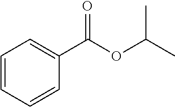 | 2.7 | 1.0 | 0.97 |
| Example 16 | isobutyl benzoate | 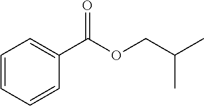 | 2.8 | 0.90 | 0.99 |
| Example 17 | ethyl 3-ethoxypropionate | 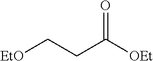 | 3.4 | 1.0 | 0.96 |
| Example 18 | butyl levulinate | 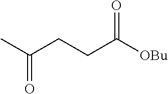 | 2.9 | 0.9 | 1.0 |
| Example 19 | diethyl succinate | 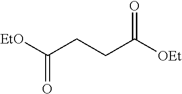 [SMILES: CCOC(=O)CCC(=O)OCC] | 2.9 | 1.1 | 0.94 |

1. A process for producing a solid catalyst component (A) for olefin polymerization, the process comprising the steps of:
(1) bringing a silicon compound (a) having a Si—O bond and an organomagnesium compound (b) into contact with one another to form a solid catalyst component precursor for olefin polymerization; and
(2) bringing the solid catalyst component precursor, a metal halide compound represented by formula (I):
MX¹_{b}(R¹)_{4-b} (I)
wherein M is an element of Group 4 of the periodic table, R¹ is a hydrocarbyl group or a hydrocarbyloxy group having 1 to 20 carbon atoms, X¹ is a halogen atom, and b is an integer number satisfying 0<b≦4,
and an internal electron donor represented by formula (II): 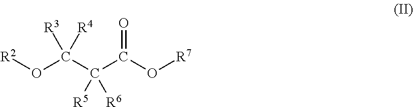
wherein R² and R⁷ are each independently a hydrocarbyl group having 1 to 20 carbon atoms and optionally having a substituent, R³, R⁴, R⁵ and R⁶ are independently a hydrogen atom, a halogen atom or a hydrocarbyl group having 1 to 20 carbon atoms and optionally having a substituent,
into contact with one another to form a solid catalyst component (A) for olefin polymerization.

2. The process according to claim 1, wherein M in the formula (I) is titanium.

3. The process according to claim 1, wherein the step (1) is a step of bringing a silicon compound (a) having a Si—O bond, an organomagnesium compound (b) and an organic acid ester (c) into contact with one another to form a solid catalyst component precursor for olefin polymerization.

4. The process according to claim 1, wherein each R³ and R⁴ in the formula (II) is a hydrogen atom.

5. The process according to claim 1, wherein R⁵ in the formula (II) is an alkyl group having 1 to 20 carbon atoms or an aryl group having 6 to 20 carbon atoms.

6. The process according to claim 1, wherein R⁵ in the formula (II) is a branched or cyclic alkyl group having 3 to 20 carbon atoms or an aryl group having 6 to 20 carbon atoms.

7. A process for producing an olefin polymerization solid catalyst, the process comprising a step of bringing the solid catalyst component (A) for olefin polymerization produced by the process according to claim 1, and an organoaluminum compound (B) into contact with one another.

8. A process for producing an olefin polymerization solid catalyst, the process comprising a step of bringing the solid catalyst component (A) for olefin polymerization produced by the process according to claim 1, an organoaluminum compound (B) and an external electron donor (C) into contact with one another.

9. A process for producing an olefin polymer, the process comprising a step of polymerizing an olefin in the presence of the olefin polymerization solid catalyst produced by the process according to claim 7.

10. The process according to claim 9, wherein the olefin is an α-olefin having 3 to 20 carbon atoms.

11. A process for producing an olefin polymer, the process comprising a step of polymerizing an olefin in the presence of the olefin polymerization solid catalyst produced by the process according to claim 8.
